(19) United States
(12) Patent Application Publication
(10) Pub. No.: US 2019/0281003 A1
(43) Pub. Date: Sep. 12, 2019

(54) SYSTEM, METHOD, AND DEVICE FOR PROVIDING NOTIFICATIONS IN GROUP COMMUNICATION

(71) Applicant: Alibaba Group Holding Limited, George Town (KY)

(72) Inventors: Xiujuan Liu, Hangzhou (CN); Lili Zhang, Hangzhou (CN); Li Shu, Hangzhou (CN)

(21) Appl. No.: 16/212,068

(22) Filed: Dec. 6, 2018

(30) Foreign Application Priority Data
Dec. 8, 2017 (CN) 201711296313.6
Jan. 30, 2018 (CN) 201810089687.9

(51) Int. Cl. H04L 12/58; H04L 29/06

(52) U.S. Cl. CPC H04L 51/24; H04L 65/403

(57) ABSTRACT

The present application discloses a method, device, and system for group communication. The method includes obtaining, by one or more processors, input content from a communication session interface, the input content comprising one or more individual notification instruction identifiers and member characteristic information, determining, by the one or more processors, one or more group members from among a predefined group, the one or more group members being determined based at least in part on the member characteristic information, and adding, by the one or more processors, individual notification instruction information for the determined one or more group members to the communication session interface.

### CROSS REFERENCE TO OTHER APPLICATIONS

This application claims priority to People's Republic of China Patent Application No. 201810089687.9 entitled COMMUNICATION METHOD AND MEANS, filed Jan. 30, 2018, which is incorporated herein by reference for all purposes, which is a divisional of People's Republic of China Patent Application No. 201711296313.6 entitled COMMUNICATION METHOD AND MEANS, filed Dec. 8, 2017, which is incorporated herein by reference for all purposes.

### FIELD OF THE INVENTION

The present invention relates to the field of communication technology. In particular, the present application relates to a method, system, and device for communicating.

### BACKGROUND OF THE INVENTION

According to the related art, a group-based form of communication is provided in response to various users being added to the same group. If one group member sends a communication session message on a communication session interface corresponding to the group, then all group members are able to receive that communication session message. Thus, highly efficient communication is achieved between group members.

However, communication within a group can result in a significant amount of messages and information being communicated and thus uses a relatively significant amount of resources. As an example, if group members in the group generate a relatively large amount of communication session messages, excessive message received prompts can be received by the group members. The message received prompts tend to disturb group members. Therefore, many group members activate the “Do Not Disturb” function on their respective devices. When the “Do Not Disturb” function is activated on a device, the device provides only a soundless received prompt or even no prompt at all in response to receiving a communication session message. Consequently, group members sometimes are unable to view relevant information promptly. According to the related art, special received prompts are provided or activated based on individual notification instruction information with respect to a communication session message. For example, the addition of individual notification instruction information for specific group members to the communication session message enables implementation of effective received prompts for group members even when at least some of the group members have activated the “Do Not Disturb” function for the group.

However, if a relatively large number of group members are to be notified simultaneously, the use of individual notification instructions for communicating to the various group members requires that the sender add individual notification instructions for each group member one at a time. The addition of individual notification instructions is inefficient, and can lead to input errors or omissions.

In view of the above, there is a need for a method, a system, and a device for communicating to a plurality of group members in a group.

### BRIEF DESCRIPTION OF THE DRAWINGS

Various embodiments of the invention are disclosed in the following detailed description and the accompanying drawings.

FIG. 1 is a diagram of a communication system according to various embodiments of the present application.

FIG. 2A is a flowchart of a method for communication according to various embodiments of the present application.

FIG. 2B is a flowchart of a method for communication according to various embodiments of the present application.

FIG. 3 is a diagram of a sending-side communication session interface according to various embodiments of the present application.

FIG. 4 is a diagram of a receiving-side communication session interface according to various embodiments of the present application.

FIG. 5 is a diagram of a group assignment interface for group members according to various embodiments of the present application.

FIGS. 6A and 6B are diagrams of a type of rapid inputting of individual notification instruction information based on groupings according to various embodiments of the present application.

FIGS. 7A through 7C are diagrams of a type of rapid inputting of individual notification instruction information based on groupings according to various embodiments of the present application.

FIG. 8 is a diagram of a type of editing of group member characteristic description tags according to various embodiments of the present application.

FIGS. 9A through 9C are diagrams of a type of rapid inputting of individual notification instruction information based on characteristic description tags according to various embodiments of the present application.

FIG. 10 is a diagram of a type of rapid inputting of individual notification instruction information based on characteristic description tags according to various embodiments of the present application.

FIGS. 11A through 11D are diagrams of a type of rapid inputting of individual notification instruction information based on characteristic description tags according to various embodiments of the present application.

FIG. 11E is a diagram of a type of rapid inputting of individual notification instruction information based on characteristic description tags according to various embodiments of the present application.

FIG. 12 is a functional diagram of a computer system for communication according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Exemplary embodiments are explained in detail here, and examples thereof are shown in the drawings. When the following descriptions relate to the drawings, the same numbers in different drawings indicate the same or similar elements, except where otherwise indicated. Implementations described in the exemplary embodiments below do not represent all implementations consistent with one or more embodiments of this specification. Rather, the implementations described in the exemplary embodiments are merely examples of means and methods that are described in detail in the claims and that are consistent with some aspects of one or more embodiments of this specification.

Please note that, in other embodiments, the corresponding method steps will not necessarily be executed according to the sequence depicted and described in the present specification. The steps included in the methods of some other embodiments may be more or fewer than what are described in the present specification. In addition, a single step described in the present specification may be described as split apart into multiple steps in other embodiments, and multiple steps described in the present specification may be described as combined into a single step in other embodiments.

As used herein, a “terminal” generally refers to a device comprising one or more processors. A terminal can be a device used (e.g., by a user) within a network system and used to communicate with one or more servers. According to various embodiments of the present disclosure, a terminal includes components that support communication functionality. For example, a terminal can be a smart phone, a server, a machine of shared power banks, information centers (such as one or more services providing information such as traffic or weather, etc.), a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a kiosk such as a vending machine, a smart home appliance, vehicle-mounted mobile stations, or the like. A terminal can run various operating systems.

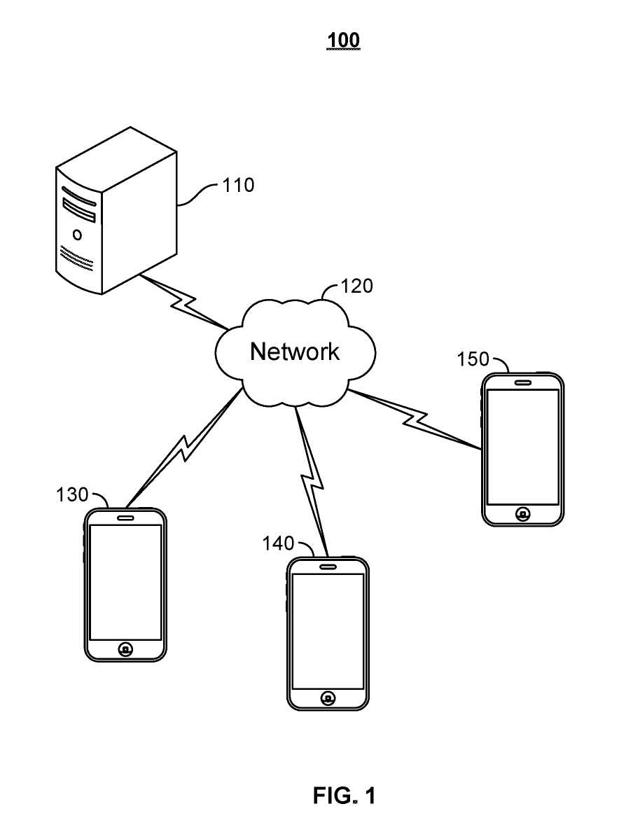

FIG. 1 is a diagram of a communication system according to various embodiments of the present application.

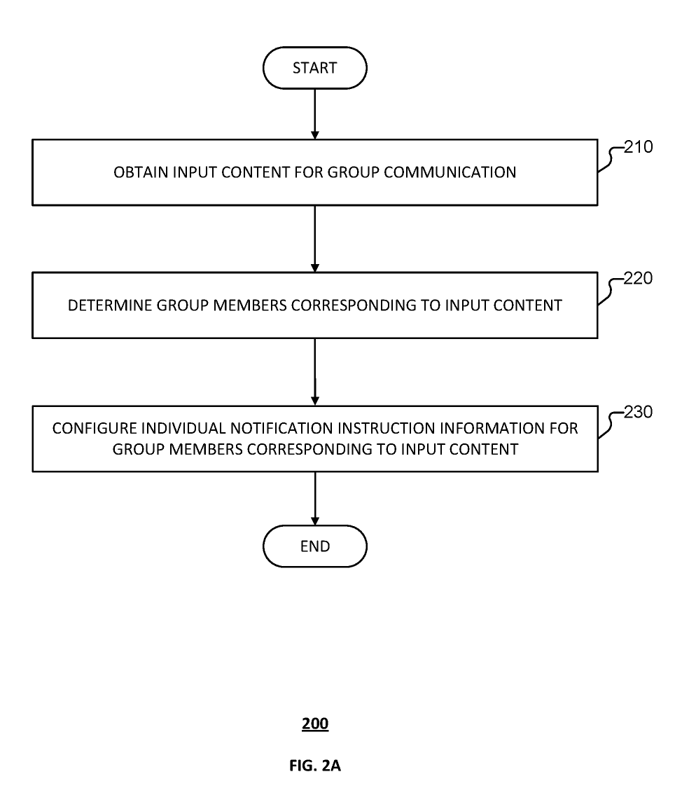

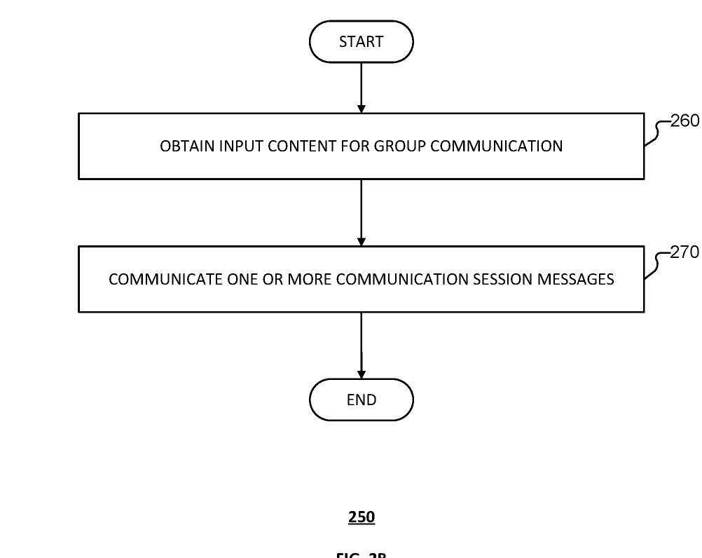

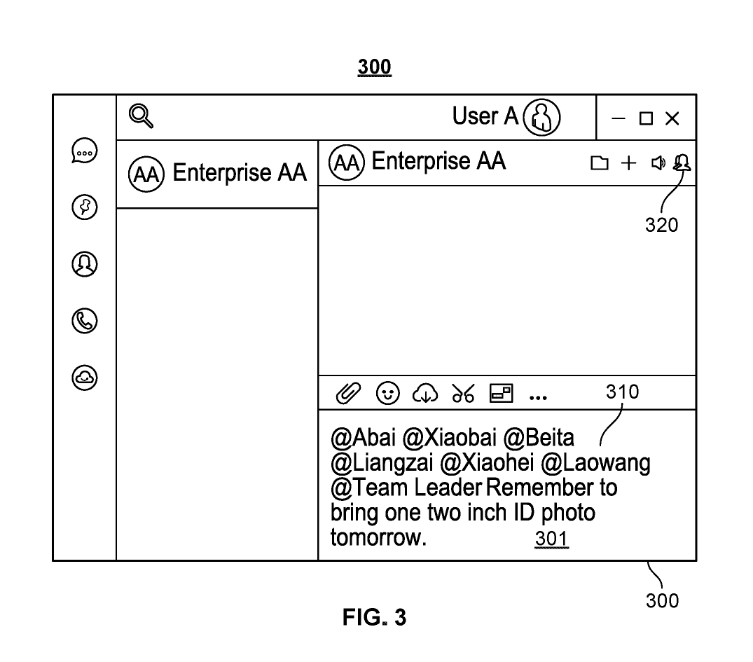

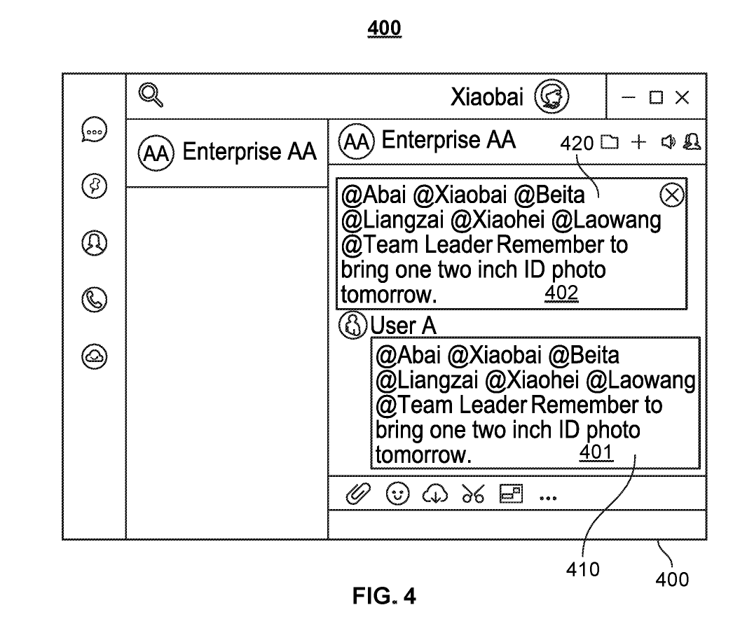

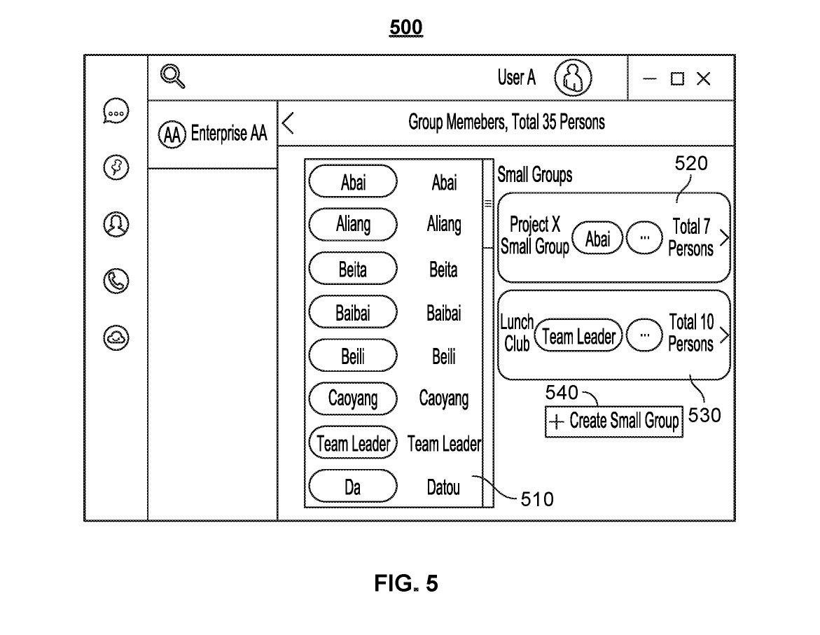

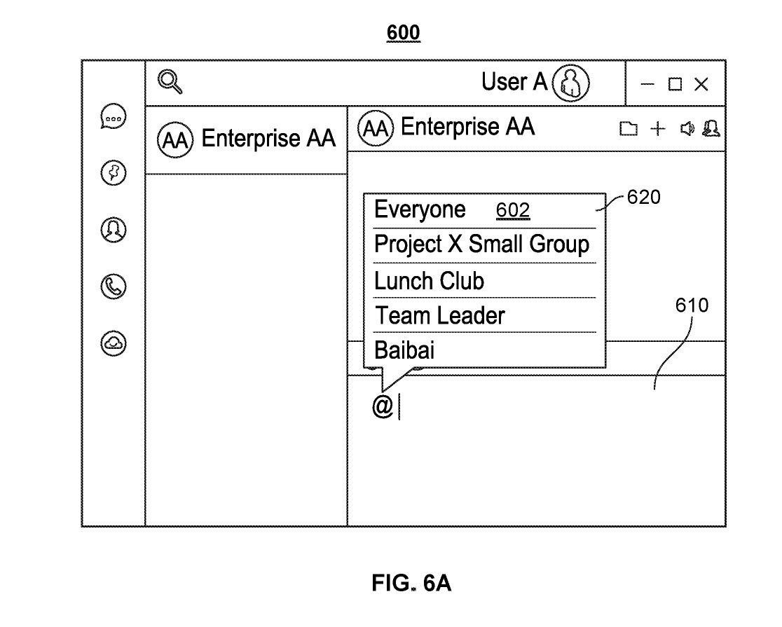

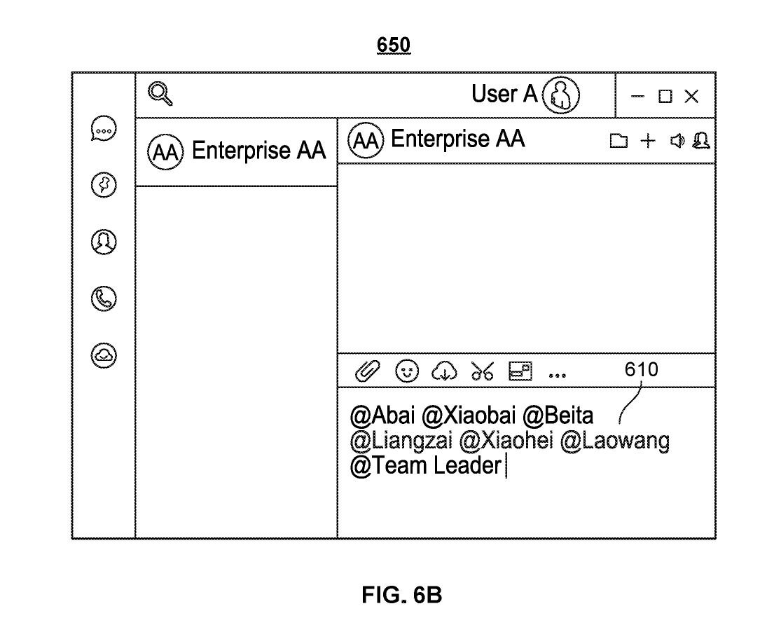

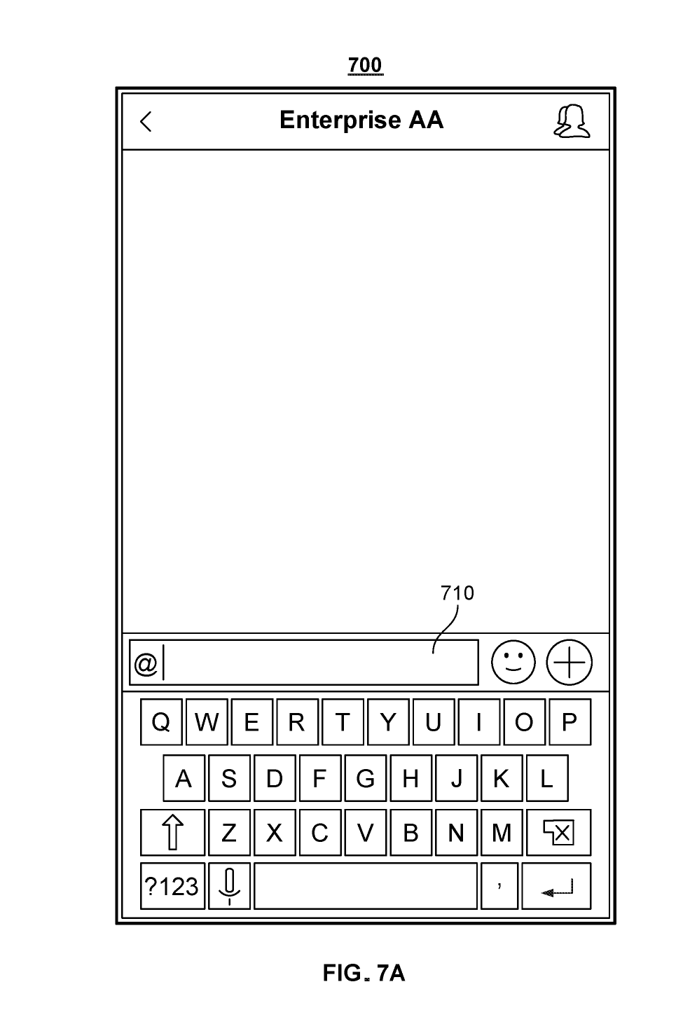

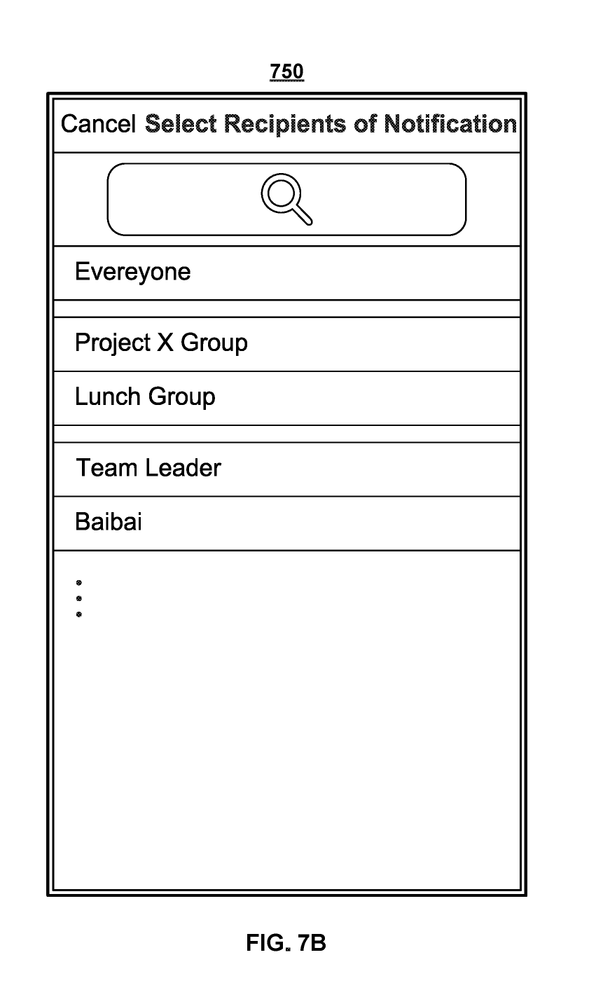

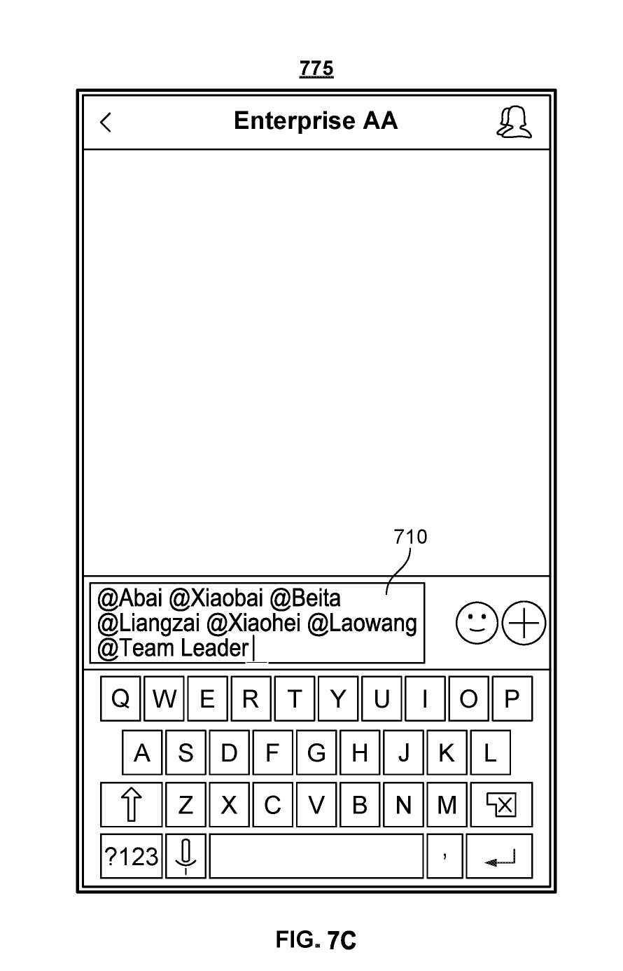

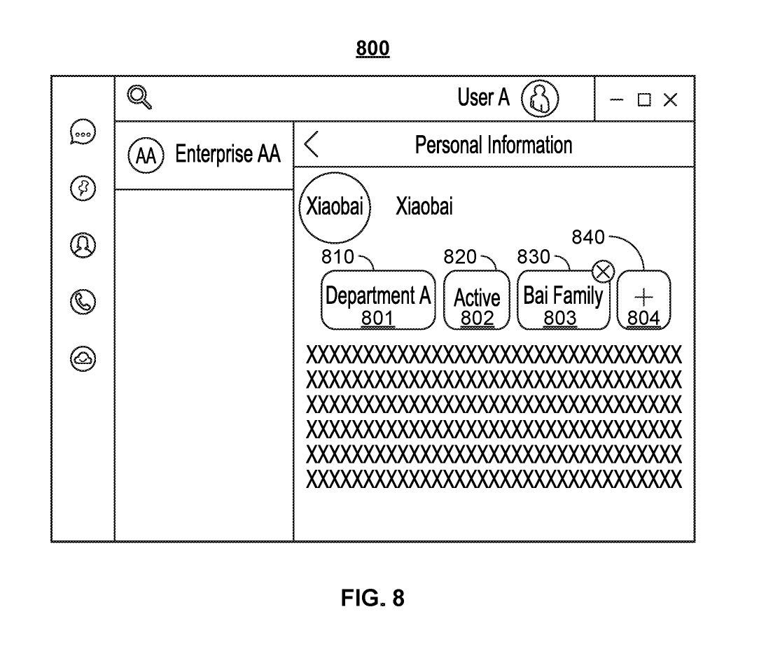

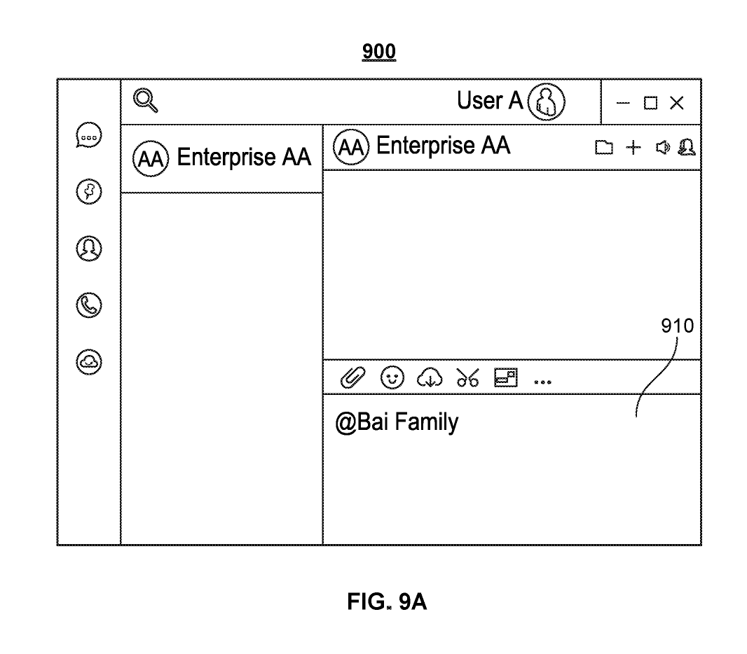

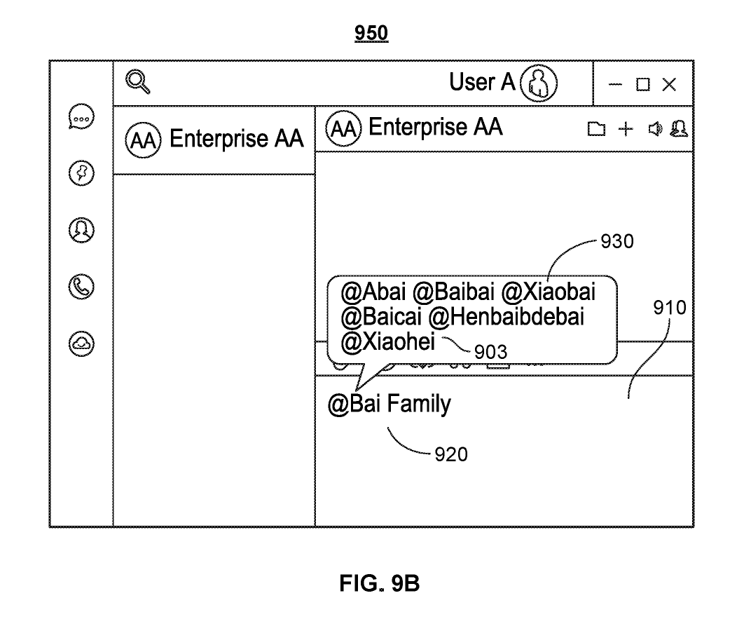

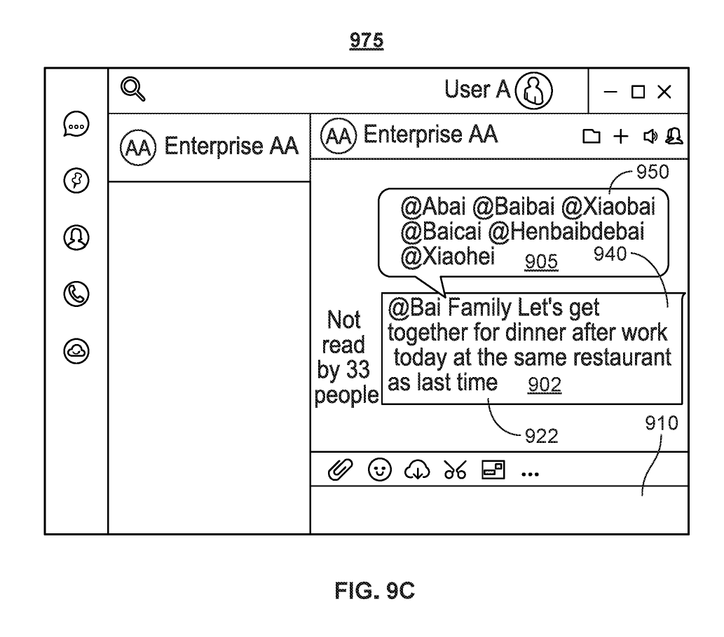

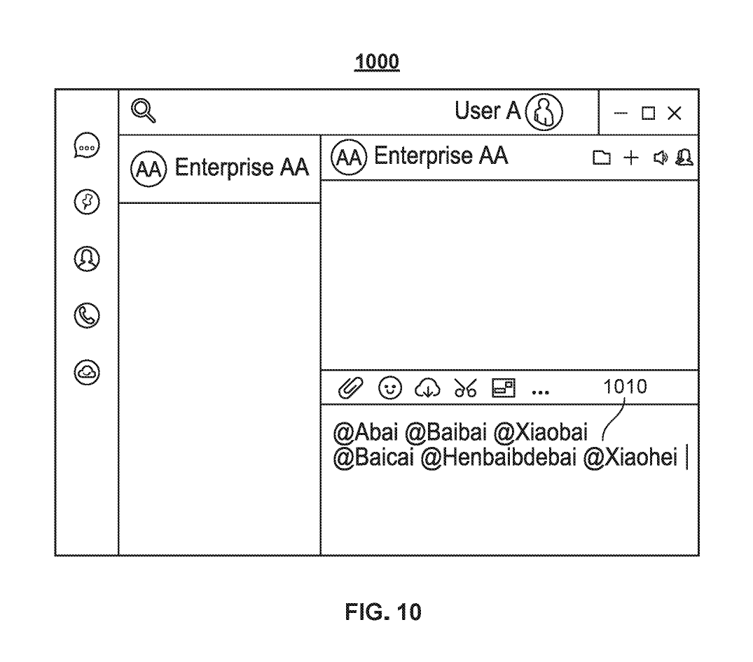

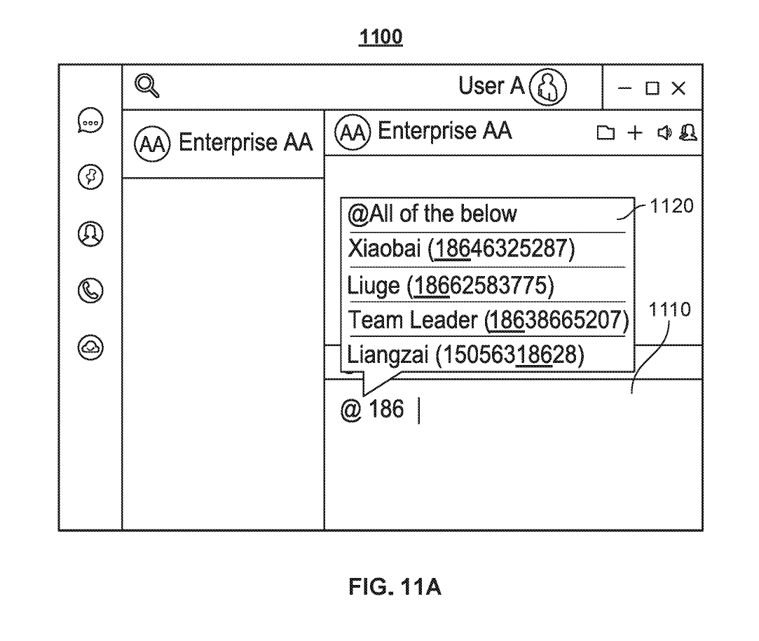

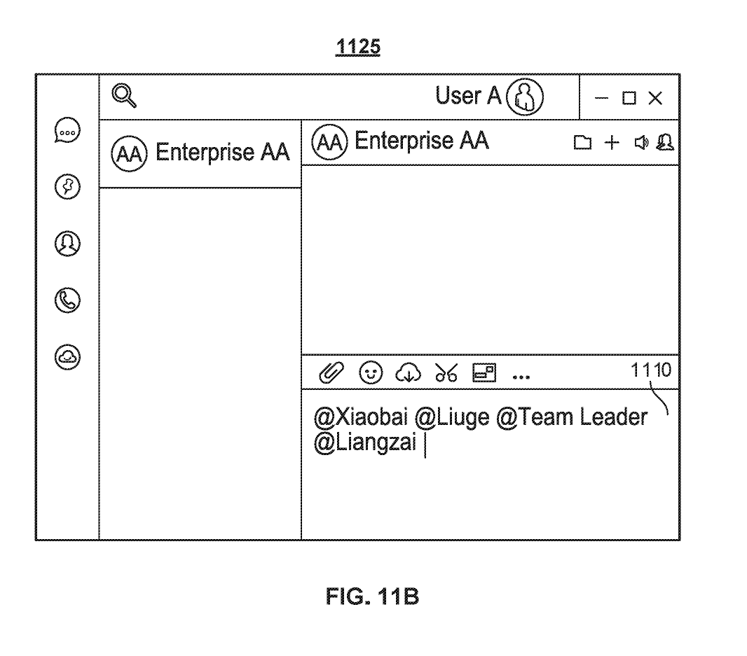

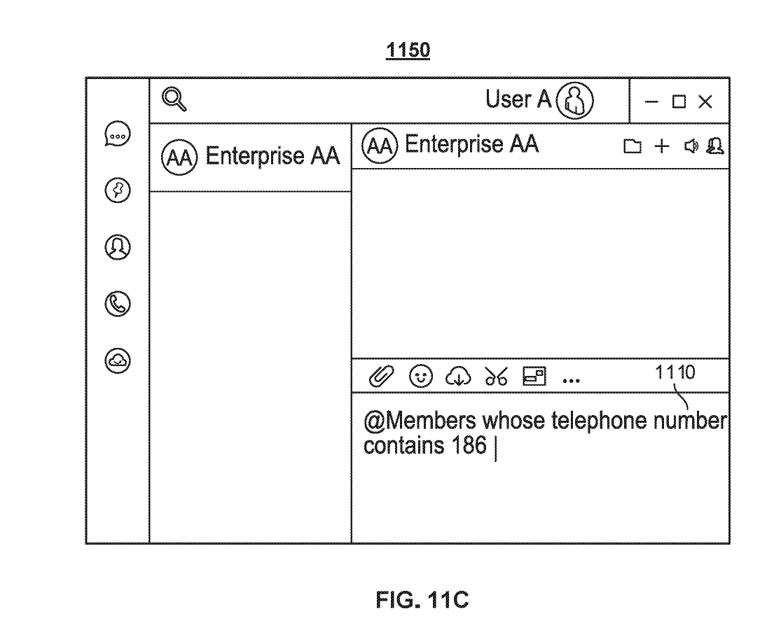

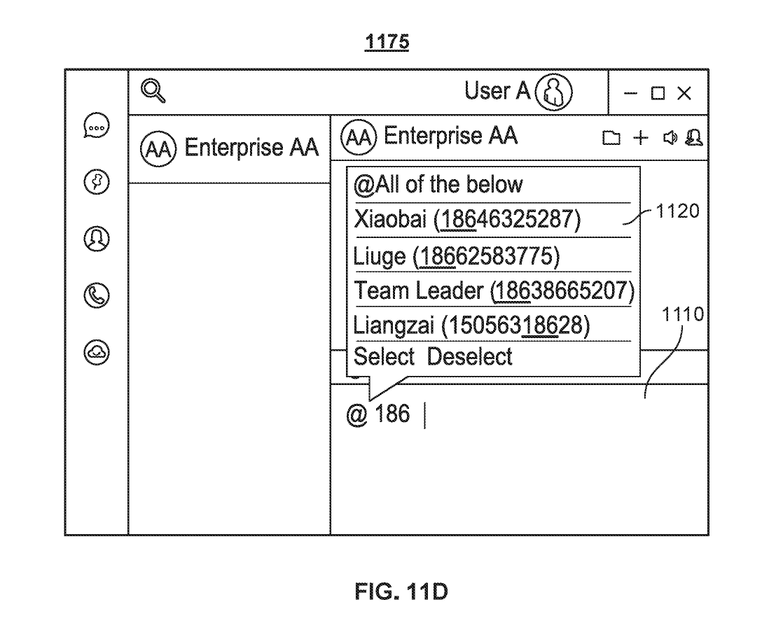

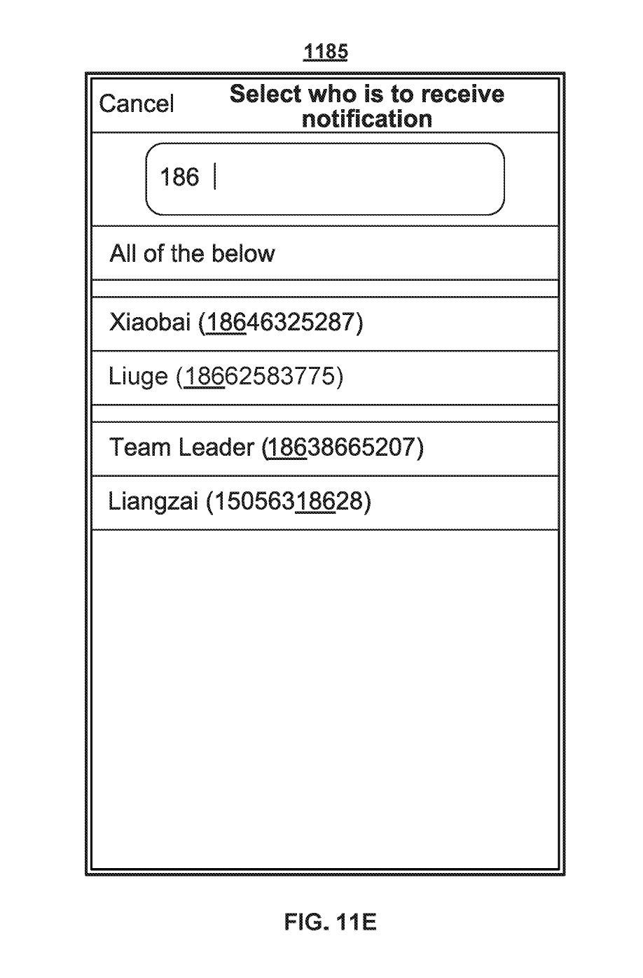

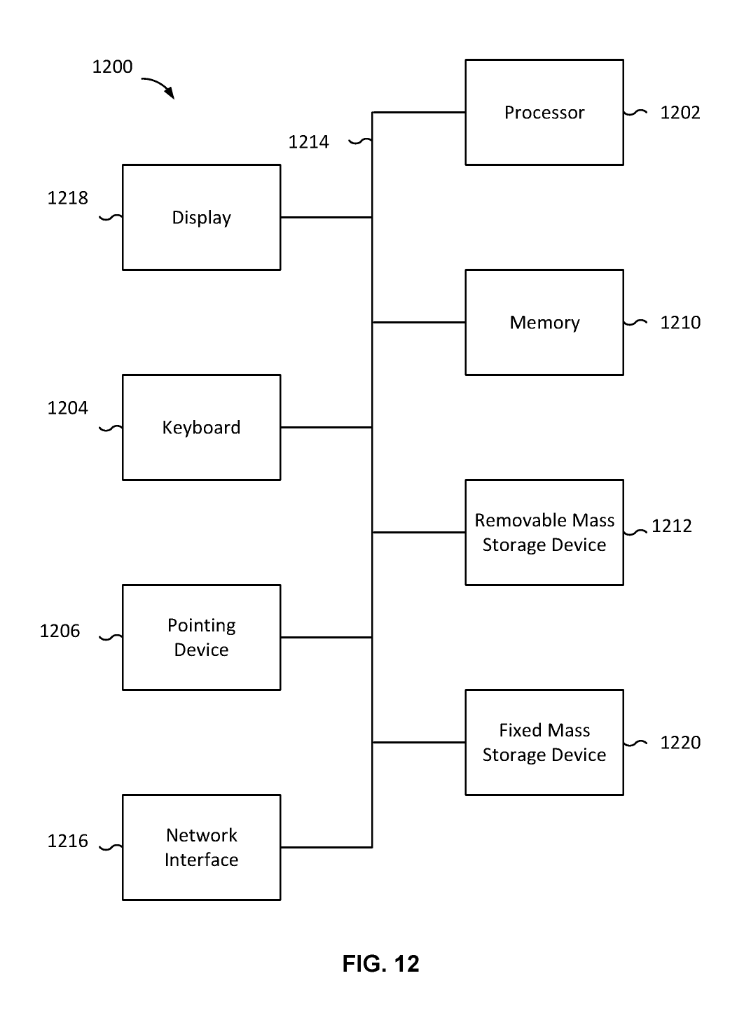

Referring to FIG. 1, system 100 for communication is provided. System 100 can implement process 200 of FIG. 2A, process 250 of FIG. 2B, interface 300 of FIG. 3, interface 400 of FIG. 4, interface 500 of FIG. 5, interface 600 of FIG. 6A, interface 650 of FIG. 6B, interface 700 of FIG. 7A, interface 750 of FIG. 7B, interface 775 of FIG. 7C, interface 800 of FIG. 8, interface 900 of FIG. 9A, interface 950 of FIG. 9B, interface 975 of FIG. 9C, interface 1000 of FIG. 10, interface 1100 of FIG. 11A, interface 1125 of FIG. 11B, interface 1150 of FIG. 11C, interface 1175 of FIG. 11D, interface 1185 of FIG. 11E, and computer system 1200 of FIG. 12.

As illustrated in FIG. 1, system 100 comprises server 110 and a plurality of terminals (e.g., mobile phone 130, mobile phone 140, and mobile phone 150). Server 110 can be connected to the plurality of terminals via one or more networks (e.g., network 120).

Server 110 can be a physical server or a virtual server. As an example, server 110 is a physical server comprising an independent host computer. As another example, server 110 is a virtual server comprised on (e.g., running on) a host computer group. According to various embodiments, server 110 runs a server-side program of an application. Server 110 can implement one or more business service functions of the application in connection with executing the server-side program of the application. For example, when server 110 runs a communication application program, server 110 implements a server for the communication application.

One or more of the plurality of terminals can run a client-side program of an application. For example, mobile device 130, mobile device 140, and/or mobile device 150 can run a client-side program of an application and implement relevant business service functions of the application. For example, when the terminal runs a communication application program, the terminal implements a client for the communication application.

According to various embodiments, a “client application program” of a communication application is pre-installed on the terminal so that the client application can be started and run on the terminal. As an example, if an online “client” application such as a client application that uses HTMLS technology is employed, the client application can be obtained and run without having to install a corresponding application program on the electronic device. In some embodiments, a client application can be downloaded and installed. For example, the user can navigate the terminal to an application store or the like and instruct the terminal to download and install the application.

According to various embodiments, a “communication application” can be an application that communicates information with another terminal or server via short messaging service (SMS), multimedia messaging service (MMS), instant messaging (IM), a chat service, etc.

According to various embodiments, the “client-side program” of the application (also referred to herein as the “client-side application”) that runs on a terminal (e.g., mobile device 130, mobile device 140, and/or mobile device 150) is associated with a “server-side program” of the application (also referred to herein as the “server-side application”) that runs on the corresponding server (e.g., server 110). The client-side application can run on one or more of the plurality of terminals and communicate with the server-side application. For example, a first terminal (e.g., mobile device 130) can communicate with a second terminal (e.g., mobile device 140) via the first terminal and the second terminal respectively running the client-side application. The first terminal can communicate with the second terminal via the respective client-side applications communicating with a server-side application running on a server to which the plurality of terminals is connected (e.g., server 110).

Network 120 via which one or more of the plurality of terminals communicate with server 110 can include multiple types of wired or wireless networks, or a combination of both. Network 120 can include a cellular network, a local network, a wide area network, or any combination thereof. Network 120 can comprise other types of networks. In some embodiments, network 120 includes a public switched telephone network (PSTN) and the Internet. As an example, a private chat can be established between any two of the plurality of terminals. As another example, a plurality of terminals communicates in a group communication (e.g., a group chat, etc.). The plurality of terminals can belong to respective group members in a same group. The group communication can be a highly efficient form of communication among the terminals in the group. The group communication (e.g., group chat) can be implemented at least in part via the communication session corresponding to the group.

FIG. 2A is a flowchart of a method for communication according to various embodiments of the present application.

Referring to FIG. 2A, process 200 for communication is provided. Process 200 can be implemented in connection with interface 300 of FIG. 3, interface 400 of FIG. 4, interface 500 of FIG. 5, interface 600 of FIG. 6A, interface 650 of FIG. 6B, interface 700 of FIG. 7A, interface 750 of FIG. 7B, interface 775 of FIG. 7C, interface 800 of FIG. 8, interface 900 of FIG. 9A, interface 950 of FIG. 9B, interface 975 of FIG. 9C, interface 1000 of FIG. 10, interface 1100 of FIG. 11A, interface 1125 of FIG. 11B, interface 1150 of FIG. 11C, interface 1175 of FIG. 11D, and/or interface 1185 of FIG. 11E. Process 200 can be implemented at least in part by system 100 of FIG. 1 and/or computer system 1200 of FIG. 12.

At 210, input content for a group communication is obtained. In some embodiments, the terminal obtains the input content (e.g., based on a user input to the terminal). The input content can be obtained in connection with a group communication. In some embodiments, the input content for the group communication is obtained in connection with an input to a group communication session interface provided at a terminal (e.g., a sending terminal). The input content can be input to the terminal via a touchscreen of the terminal, etc. The input content for the group communication can be input in connection with a group communication (e.g., a communication to be sent to a group comprising a set of group members).

According to various embodiments, a group for which the input content for the group communication is predefined. For example, the group is predefined based on selection (e.g., by a user) of a group with which the user desired to communicate. The group can be selected via a user interface provided by an application that provides group communication. In some embodiments, a user selects one or more users to set as a group. In some embodiments, an administrator defines the group such as by selecting one or more users to be comprised in the group.

According to various embodiments, the input content comprises “individual notification instruction identifiers” and/or “member characteristic information.” Additional details of “individual notification instruction identifiers” and “member characteristic information” will be described below. A user can input one or more of individual notification instruction identifiers and member characteristic information to the terminal (e.g., to a group communication session interface). As an example, a client-side application for communication between or among terminals (e.g., a client-side communication application) can provide a group communication session interface on the terminal and the input content can be input into an input field/window/box of the group communication session interface. In some embodiments, the input content can correspond to user input content. The individual notification instruction identifiers and/or the member characteristic information can be defined by a developer of the corresponding application (e.g., the client-side application), an administrator of the corresponding application (e.g., an administrator associated with an enterprise-side communication application), a user (e.g., a user of the client-side application).

In some embodiments, an application program run on terminals (e.g., client-side applications) has communication functions (e.g., the client-side applications comprise communication applications). According to various embodiments, the communication application implements the communication between or among terminals. The communication application implementing various embodiments can be of various types of a communication application (e.g., an instant messaging application, an enterprise instant messaging application, a texting application, an e-mail application, etc.). In some embodiments, the communication application is a client for a mobile organization office platform.

In some embodiments, input content is input by a user. As an example, the input content can be input to a terminal via a keyboard (e.g., a keyboard connected to the terminal via a wired or wireless connection, a keyboard on a touchscreen of the terminal, etc.). As another example, the input content is input by a user via a pasting from a clipboard. As another example, the input content is input via speech input. For example, speech input can be obtained by the terminal and converted from the speech input (e.g., recorded user speech) into text. The input content can be input via various other input technologies.

In some embodiments, “an individual notification instruction identifier” is a certain identifier. For example, the individual notification instruction identifier can be a pre-defined identifier (e.g., a character, numerals, or text). As a specific example, the individual notification instruction identifier can be “@.” The individual notification instruction identifier can be configured (e.g., set or predefined) by an application developer (e.g., a developer of the communication application), an administrator, a user, etc. In some embodiments, the individual notification instruction identifier is configured to an identifier (e.g., a value) that is not commonly used. For example, the individual notification instruction identifier is configured to be an identifier that is not commonly used during operation of the terminal, or during operation of the corresponding application (e.g., the client-side communication application or other application for which the individual notification instruction identifier is set). The setting of an individual notification instruction identifier to correspond to an identifier that is not commonly used can increase the accuracy of determining intent of the user corresponding to the user input. For example, if the individual notification instruction identifier is an identifier that is not commonly used, then the determining that the terminal obtains an input corresponding to the individual notification instruction identifier comprises deeming that the user intended to input the individual notification instruction identifier (e.g., to invoke a function or setting corresponding to the individual notification instruction identifier, etc.). According to various embodiments, by setting the individual notification instruction identifier to be an uncommonly used identifier, then an individual notification instruction can be easily and quickly identified within input content.

According to various embodiments, an individual notification instruction identifier corresponds to an instruction to set an individual notification. In some embodiments, the individual notification instruction identifier is used to identify the users of a group for which an individual notification is to be set. As an example, individual notification instruction identifier denotes a user intent or trigger to send an individual notification to each of the group members that is identified by/matched to the member characteristic information that follow the individual notification instruction identifier.

In some embodiments, one or more groups can be configured (e.g., set or defined) in connection with an application (e.g., a client-side application such as a communication application installed on a terminal, or a server-side application running on a server with which a terminal can communicate). The one or more groups can correspondingly comprise a plurality of users. For example, a group can be configured based at least in part on an association of a plurality of identifiers respectively corresponding to a plurality of users (e.g., users registered with an application or a service corresponding to the application). The one or more groups can be configured by an administrator, a service provider, a user associated with the application or service corresponding to the application, a user of the terminal, etc.

In some embodiments, one or more subset groups may be pre-created within a group. A subset group is smaller than the group within which the subset group is created. Each subset group comprises at least one group member of the group. In some embodiments, all members within the subset group are also members of the group (e.g., the group within which the subset group is created). The one or more groups and/or the one or more subset groups can be configured based at least in part on one or more of member characteristic information and one or more determined group members. In some embodiments, “member characteristic information” can comprise a “group identifier” for at least one subset group. The determined group members comprise group members comprised within the corresponding group (e.g., members within at least one subset group, or within one of the one or more groups). In some embodiments, a group or subset group is created in advance by the group creator, by an administrator, or by any group member (e.g., in the case of creation of a subset group). The one or more subset groups created within a group can be visible to one or more members of the group. As an example, the subset group can be visible to all group members of the group within which the subset group is created. For example, all group members can determine (e.g., search, lookup, etc.) the group identifiers of the one or more subset groups. In some embodiments, the group identifiers are used in connection with the configuring or input of member characteristic information. In some embodiments, one or more subset groups created within a group are selectively visible to one or more users. For example, an administrator, group creator, etc. can select one or more users that have permission or access rights to the subset group. In some embodiments, a subset group created within a group is visible to only some group members of the group within which the subset group is created. For example, a subset group is visible only to the group members who belong to the subset group. Group members who do not belong to the subset group cannot obtain (e.g., search or lookup) the group identifier corresponding to the subset group. As another example, the subset group is visible only to the creator of the subset group (e.g., the user that created the subset group). According to various embodiments, a user such as a group member can separately create a subset group within the group in accordance with the user's own needs or preferences. In some embodiments, users of the application that are not within the group from which the subset group is formed cannot obtain the group identifier corresponding to the subset group (or otherwise find the subset group in a search or lookup). For example, only group members of the group from which the subset group is formed (or only group members included in the subset group) can obtain the group identifier corresponding to the subset group.

In various embodiments, the input content can comprise member characteristic information that follows an individual notification instruction identifier. In some embodiments, member characteristic information comprises information from which one or more group members of a group or a subset group can be identified. In some embodiments, member characteristic information can comprise an email domain, an email address, etc. In some embodiments, member characteristic information can comprise “characteristic description tags.” According to various embodiments, a characteristic description tag comprises information relating to a corresponding group member. The identified group members can comprise group members that are associated with member characteristic information pertaining to a group or a subset group. For example, the identified group members can comprise group members with which characteristic description tags are associated within the group (or subset group). According to various embodiments, a characteristic description tag comprises a system preset tag or a self-defined tag. The characteristic description tag can include at least one of: a self-descriptive tag (e.g., a tag pertaining to a group member that is self-added or configured by the group member), an other-descriptive tag (e.g., a tag added by another group member), a system-descriptive tag (e.g., a tag that is automatically added in accordance with information pertaining to any group member such as personal information about the group member, past messages, historical records of operations, and data about relationships with other users, etc.), or description tags (e.g., tags that are added or associated with a group member through other channels or inputs). The adding of a tag can comprise associating the characteristic description tags with a corresponding group member with a group, or updating a mapping of group members to groups to associate a tag with a group member or a group, or to associate a group member with a group. According to various embodiments, mappings (e.g., a mapping of group members to groups to associate a tag with a group member or a group, or to associate a group member with a group) are stored locally at a terminal or at a server such as a server providing a service associated with a client-side application.

As mentioned above, according to various embodiments, a characteristic description tag comprises information relating to a corresponding group member. The information relating to the group member can comprise an indication of a characteristic of the group member. For example the characteristic description tag can comprise information pertaining to a name, an alias, a gender, a position, an employer, a work department, a telephone number, a mailing address, an email address, etc., of the corresponding group member. The information pertaining to a characteristic of the group member can be self-added or configured by the group member, added or configured by another group member, added or configured by an administrator, or added or configured by the system. In some embodiments, the characteristic description tag is not specifically generated and presented in the form of a “tag.” For example, the characteristic description tag can be information stored in a mapping of information to group members or a mapping of information to groups. As an example, in response to a group member inputting personal information (e.g., such as name, telephone number, email address, etc.) into a personal information interface (e.g., provided at a client-side such as in a client-side application), the corresponding input personal information is associated with the group member and can be deemed a “characteristic description tag” of the group member. In some embodiments, the “characteristic description tag” is a “tag” that is additionally generated according to information relating to the group member. For example, the “characteristic description tag” is presented in a specific form on a specific interface (e.g., at a client-side interface such as in the client-side application) and each characteristic description tag can be added, edited, or deleted based at least in part on (e.g., and in response to) individual additions, edits, deletions, and other such maintenance operations to the specific interface with respect to a group member associated with the characteristic description tag.

According to various embodiments, characteristic description tags can be associated with more than one group member at one time. For example, information pertaining to characteristics of a plurality of group members can be obtained and associated with the plurality of group members (e.g., in the form of a characteristic description tag, etc.).

In some embodiments, the characteristic description tags are pre-added or pre-configured by the inputter of the user input content for corresponding group members. The characteristic description tags can be input contemporaneously with the input of the user input content. The characteristic description tags can be invisible to group members other than the inputter. For example, the characteristic description tags may be visible to the inputter only so as to meet the requirements or preferences of the inputter without having any effect on other group members. The characteristic description tags can be visible only to the inputter at the client-side application. For example, a user can individually characterize or configure groups or subset groups of users for group communication, and/or the user can set or define characteristic description tags for the group or subset group, or the group members thereof. In some embodiments, the characteristic description tags are visible to a plurality of group members or all the group members. For example, a group member can obtain the characteristic description tags or obtain or identify group members corresponding to the characteristic description tags and input individual notification instruction information for one or more of the group members corresponding to the characteristic description tags. The individual notification instruction information for one or more of the group members corresponding to the characteristic description tags can be input in the input box (e.g., provided at an interface of the client-side application, etc.). The look-up of one or more group members corresponding to the characteristic description tags and the input of individual notification instruction information for such one or more group members can ensure a more efficient and effective method for defining or inputting individual notification instruction information for users (e.g., group members). The look-ups (e.g., the look-up of one or more group members corresponding to the characteristic description tags) can be performed locally at the terminal (e.g., via the client-side application) or remotely at a server providing a service (e.g., via the server-side application). In some embodiments, the group members (or a plurality of group members) of one group can simultaneously have characteristic description tags, and the characteristic description tags are visible to only some group members (e.g., the group members who added the characteristic description tags or the group members with whom the characteristic description tags are associated) or to all group members (or an otherwise defined subset of group members of the corresponding one group).

In some embodiments, the group members of a group belong to the same organization. For example, the group members can work for the same company, belong to the same social group, belong to the same department, or organizational unit within an organization such as a company, an association, a school, etc. As an example, a group can correspond to employees of a company, and a subgroup associated with the group can comprise employees of a department of the company. The member characteristic information can comprise: dimensional information comprised in (or defined by) the organizational structure of the organization. The group members of a group can comprise: group members conforming to the dimensional information within the group. For example, the dimensional information comprises at least one of: a departmental identifier, a position grade identifier, a work type identifier, and an indication of a number of years of having worked or a number of years of experience, etc. Therefore, when the communication is implemented using a mobile organization office platform (e.g., a client-side application and a server-side application that interface with one another), the organizational management functions of the mobile organization office platform can obtain the organizational structure of an organization. Accordingly, various embodiments can be rapidly and conveniently implemented through interactions between organizational management functions and communication functions.

In some embodiments, group members of a group belong to multiple organizations. The member characteristic information can comprise: organization information, and the determined group member can comprise: group members belonging to corresponding organizations within the group. In some embodiments, if the group members of the group belong to multiple organizations, the group is a trans-organizational group. By using organizational information as member characteristic information, a user can quickly reference group members of the same organization and quickly add individual notification instruction information for a group member (e.g., the referenced group members or a subset thereof) in an input box. In some embodiments, if the group members of the group belong to multiple organizations, the group members respectively belong to a plurality of groups with each group being associated with the corresponding organization to which the group members belong.

According to various embodiments, individual notification instruction identifiers and/or member characteristic information associated with group members is manually input by a user into an interface for a client-side application or an administrator using an interface associated with a server-side application, etc.

According to various embodiments, in response to obtaining input content, the terminal determines whether the input content comprises an individual notification instruction identifier. For example, the terminal can determine whether the input content comprises a field pertaining to the individual notification instruction identifier. In some embodiments, the input content can be input to an interface provided on the terminal (e.g., the group communication session interface provided by the terminal). The interface on the terminal can comprise a field within which an individual notification instruction identifier is input. In response to a submission (or input) to the interface on the terminal, the terminal can determine whether the field associated within which an individual notification instruction identifier is to be input comprises any information. In some embodiments, the terminal determines whether the input content comprises one or more individual notification instruction identifiers based at least in part on whether the input content is configured according to a preset format (e.g., a format comprising a field for an individual notification instruction identifier).

According to various embodiments, if the user input content comprises an individual notification instruction identifier (e.g., if the terminal determines that the input content comprises the individual notification instruction identifier), an information selection interface is provided. For example, in response to determining that the user input comprises an individual notification instruction identifier, the terminal (e.g., the client-side application) displays an information selection interface. The information selection interface can be automatically provided in response to a determination that user input comprises an individual notification instruction identifier. The information selection interface can comprise candidate member characteristic information. According to various embodiments, the information selection interface is provided in connection with a group communication and user input can be obtained via the information selection interface with respect to one or more group members. For example, a user can configure settings (e.g., group communication settings) pertaining to one or more group members via the information selection interface, or select the one or more group members for whom the settings are to be configured. Information selection instructions can be obtained via the information selection interface. For example, a user inputs the information selection instruction into the information selection interface (e.g., provided by the terminal by the client-side application). According to various embodiments, the information selection instruction serves as a basis to set the selected candidate member characteristic information to the member characteristic information in the user input content. For example, the user input can be obtained based at least in part on the individual notification instruction identifiers and the obtained information selection instruction. The individual notification instruction identifiers input by users (e.g., manually input by a user) and the selected member characteristic information can jointly constitute the user input content described above.

Accordingly, manual input of member characteristic information, as is common in the related art, becomes unnecessary in various embodiments. In particular, when a large volume of member characteristic information exists, various embodiments do not require a user to remember each piece of such member characteristic information. Therefore, various embodiments lower the learning threshold for group members and facilitate rapid entry of input member characteristic information.

At 220, group members corresponding to the input content are determined.

According to various embodiments, the terminal determines the group members corresponding to the input content. In some embodiments, a server determines the group members corresponding to the input content (e.g., in response to the terminal providing the input content or a portion thereof to the server such as via a communication between a client-side application and a server-side application). The group members corresponding to the input content can be determined in response to the obtaining of the input content.

According to various embodiments, the group members corresponding to the input content are determined based at least in part on the member characteristic information. For example, the member characteristic information can be obtained based at least in part on (e.g., from) the input content. The group members corresponding to the input content can be comprised in a same group (e.g., a group associated with the input content).

According to various embodiments, group members in the group that correspond to the member characteristic information are automatically determined according to member characteristic information comprised in the input content (e.g., user input content). The group members can be determined based at least in part on querying a mapping of member characteristic information to users (or group members), or otherwise searching for members corresponding to the member characteristic information.

According to various embodiments, a member selection interface is presented in response to a determination that input content comprises an individual notification instruction identifier. For example, in response to detecting (e.g., determining) that the user input content includes the individual notification instruction identifier, a member selection interface is provided (e.g., displayed). A client-side application can cause the terminal to display the member selection interface. The member selection interface can comprise group members matched to the user input content (e.g., member characteristic information). For example, the member selection interface can be configured based at least in part on the group members that are determined to correspond to the input content (e.g., member characteristic information). According to various embodiments, a member selection instruction is obtained via the member selection interface. For example, the terminal obtains the member selection instruction based at least in part on an input (e.g., by a user) to the member selection interface. In response to receiving the received member selection instruction, the group members corresponding to the member characteristic information are determined. For example, the received member selection instruction serves as a basis to determine the selected group members as the group members corresponding to the member characteristic information. In some embodiments, the member selection instruction comprises a selection of one or more group members corresponding to the user input content. For example, if the user input content is “@186,” where “@” is the individual notification instruction identifier and “186” is the member characteristic information, then the member selection interface provides (e.g., displays) all the group members having a corresponding telephone number that includes “186.” Accordingly, the group members can be quickly searched for group members corresponding to the user input content. In some embodiments, one or more group members provided on the member selection interface are determined based on (e.g., in response to) a query based at least in part on the member characteristic information comprised in the user input content, etc.

At 230, individual notification instruction information is configured for one or more group members corresponding to the input content. According to various embodiments, the individual notification instruction information is configured for the group members in response to the determining of the group members corresponding to the user input. The individual notification instruction information can be configured by the terminal (e.g., the client-side application). In some embodiments, a server-side application that communicates with the terminal configures the individual notification instruction information. According to various embodiments, the configuring the individual notification instruction information comprises adding the individual notification instruction information (e.g., for the determined group members) to the communication session interface. The individual notification instruction information can be added to the communication session interface to set the determined group members to be individually notified (e.g., for notifications sent to the corresponding group members to be configured for group members on a group member-by-group member basis, or a set of group members-by-set of group members basis). The determined group members can be notified upon reception of the corresponding message, upon executing or loading the client-side application, etc. The individual notification instruction information can have a format of “@” used in conjunction with the corresponding group member (e.g., an identifier corresponding to the applicable group member). The individual notification instruction information can indicate a form of the notification. For example, the individual notification instruction information can indicate whether the notification is to be a pop-up, a predefined alert, a particular notification sound, etc. In some embodiments, if individual notification instruction information is defined only with respect to a subset of group members, the message can be sent to all members of the group, and only those subset of group members for which the individual notification instruction information is defined can receive the corresponding notification (e.g., the message can be presented as a normal message to the other members of the group). In some embodiments, if individual notification instruction information is defined only with respect to a subset of group members, the message is sent only to the subset of group members for which the individual notification instruction information is defined.

According to various embodiments the individual notification instruction information comprises a predefined value or character and/or an identifier of each group member that is determined to match the member characteristic information. For example, the individual notification instruction information for a particular group member that is determined to match the member characteristic information can correspond to the form of “@+member name,” etc. Other forms or formats of the individual notification instruction information can be implemented. As an example, in the case of the individual notification instruction information taking the form of “@+member name,” if “member name” is the name information for the present terminal user in a group chat message, then the group chat message can be deemed to comprise individual notification instruction information for the present terminal user. For example, in response to receiving a group chat message, a terminal can determine whether the group chat message comprises an individual notification instruction information associated with the terminal (e.g., the terminal that received the group chat message) or a user associated with the terminal. In response to determining that the group chat message comprises an individual notification instruction information associated with the terminal (e.g., the terminal that received the group chat message) or a user associated with the terminal, or that the terminal otherwise obtains (e.g., receives) the individual notification instruction information, then the terminal can perform a corresponding function, etc. As an example, the corresponding function can correspond to performing a predefined or corresponding notification. According to various embodiments, individual notification instruction information has higher notification permission. For example, the individual notification instruction information can be deemed to have a higher priority than a locally set notification setting of the terminal that receives the individual notification instruction information. If the terminal that receives the individual notification instruction information has a local setting of silent or “Do Not Disturb,” the individual notification instruction information can at least temporarily override such a setting and provide a notification (e.g., a notification set according to a sending user's preferences or settings) to the terminal (e.g., the receiving terminal). As an example of the individual notification instruction information having a higher notification permission, even if a communication session of the corresponding group has been blocked (e.g., the “Do Not Disturb” function has been activated), a corresponding message received alert can be triggered (e.g., performed) provided that the group chat message contains individual notification instruction information for the present terminal user. In embodiments, if a group chat message comprises individual notification instruction information for the present terminal user, a special received prompt is still implemented for the present terminal user. For example, to ensure that the present terminal user can notice and view the content of the group chat message, the group chat message may be continually presented through a floating window in the communication session interface of the group until the floating window is manually shut.

According to various embodiments, individual notification instruction information is added to information sent to one or more other terminals (e.g., via a server-side application or service that communicates with a plurality of terminal) based at least in part on the group members corresponding to the group characteristic information. For example, user input information comprising individual notification instruction identifiers and member characteristic information is used to add corresponding individual notification instruction information to an input box (e.g., provided on an interface displayed on the terminal such as an interface for a communication application) according to the group members corresponding to the group characteristic information. The corresponding individual notification instruction information can be automatically added to the input box. For example, in response to obtaining the individual notification instruction identifiers and member characteristic information, the terminal can input the corresponding individual notification instruction information to the input box (e.g., without a specific user request associated with adding such information to the input box). Accordingly, if the user wants to add individual notification instruction information for a relatively large number of users, the user can quickly input an individual notification instruction information without having to manually input the individual notification instruction information one piece at a time. For example, the user can input the individual notification instruction information for one or more group members at the same time. In some embodiments, the user can input the individual notification instruction information for a plurality of group members at the same time and can selectively input the individual notification instruction information for a subset of all group members belonging to a particular group. The user can select a plurality of group members for which the individual notification instruction information is to apply. The plurality of group members can be selected based at least in part on one or more characteristics of the plurality of group (e.g., based on member characteristic information). The plurality of group members can be a subset of the group to which the plurality of group members belong. Accordingly, various embodiments improve the efficiency and simplify user operations for setting or configuring individual notification instruction information for group members (e.g., for a plurality of group members). In addition, various embodiments further prevent input operations or omissions and ensure that information is accurately conveyed.

FIG. 2B is a flowchart of a method for communication according to various embodiments of the present application.

Referring to FIG. 2B, process 250 for communication is provided. Process 250 can be implemented in connection with interface 300 of FIG. 3, interface 400 of FIG. 4, interface 500 of FIG. 5, interface 600 of FIG. 6A, interface 650 of FIG. 6B, interface 700 of FIG. 7A, interface 750 of FIG. 7B, interface 775 of FIG. 7C, interface 800 of FIG. 8, interface 900 of FIG. 9A, interface 950 of FIG. 9B, interface 975 of FIG. 9C, interface 1000 of FIG. 10, interface 1100 of FIG. 11A, interface 1125 of FIG. 11B, interface 1150 of FIG. 11C, interface 1175 of FIG. 11D, and/or interface 1185 of FIG. 11E. Process 250 can be implemented at least in part by system 100 of FIG. 1 and/or computer system 1200 of FIG. 12.

At 260, input content for a group communication is obtained. In some embodiments, the terminal obtains the input content for group communication. According to various embodiments, the input content is obtained from a communication session interface. For example, the input content is input to a communication session interface (e.g., that is provided or displayed by a terminal), and in response to input of the input content to the communication session interface, the input content is obtained. The input content (e.g., user input content) comprises individual notification instruction identifiers and member characteristic information.

According to various embodiments, the input content is input in connection with a client-side application running on a terminal. For example, the client-side application can cause the terminal to display the communication session interface via which the input content is input. The client-side application can correspond to a communication application such as a group communication application or a communication application that supports group communication such as a group chat or group messaging functionality (e.g., to send a message to a plurality of users in a predefined group, etc.).

According to various embodiments, the client-side application implements the communication among a group of users. The client-side application can send a message to a plurality of users (e.g., a plurality of terminals) via a network. For example, the terminal running the client-side application can send communication information pertaining to the message to a server. In response to the server receiving the communication information, the server can determine the users or terminals to which to forward or send the communication information (e.g., the server determines the intended recipients). The server can run a server-side application that interacts with a client-side application (e.g., interfaces or otherwise facilitates communication among terminals that run a client-side application). For example, the server-side application can provide a service to one or more terminals (e.g., terminals associated with users that have registered for the service, etc.). In some embodiments, the application (e.g., the corresponding client-side application and/or server-side application) comprises a communication application (e.g., an instant messaging application, an enterprise instant messaging application, etc.). Various embodiments can implement various other applications. For example, the application can be a client for a mobile organization office platform.

According to various embodiments, the input content is input by a user to the communication session interface based on an input to a touchscreen of the terminal, a voice input, and/or an input to a keyboard or other input device connected to the terminal, etc. As an example, user input content is input by a user through a keyboard (e.g., a soft keyboard that is displayed on a touchscreen). As another example, the user input content is input by a user by pasting the input content (or a portion thereof) from a clipboard. As another example, the user input content is input in connection with converting user speech into text or by selecting input from candidate input information presented on an electronic device, etc. Various other technologies for inputting input content can be implemented.

According to various embodiments, a notification instruction identifier is a pre-defined identifier. Various identifiers can be set to correspond to a notification instruction identifier. For example, the pre-defined identifier is one or more of characters, special characters, numerals, or text, or any combination thereof. The pre-defined identifier can be set to be an identifier that is not commonly used (e.g., during normal operation of the terminal). For example, a notification instruction identifier that is not a commonly used identifier increases the accuracy of user input intention assessments.

According to various embodiments, one or more subset groups are pre-created within said group. Each subset group can comprise at least one group member of the group (e.g., the group within which the subset group is created). The member characteristic information can comprise a group identifier for at least one subset group. The determined group members comprise group members comprised within the at least one subset group. The one or more subset groups within the group can be created according to various implementations. For example, a subset group is created in advance by the group creator or administrator or by any group member of the group (e.g., the group within which the subset group is created). As an example, the one or more subset groups created within the group are visible to all group members. If the one or more subset groups are visible to all group members of the group within which the corresponding subset group is created, all group members of the group can determine (e.g., search, identify, lookup, etc.) the group identifiers of the one more subset groups. The group identifiers of the one or more subset groups can be used (e.g., by the group members such as the group members to which the group identifiers are visible) in connection with the input of the member characteristic information. As another example, the one or more subset groups created within the group are visible to only some group members. A subset group can be visible only to the group members who belong to the corresponding subset group. If the subset group is visible only to the group members who belong to the corresponding subset group, group members who do not belong to the subset group cannot determine (e.g., search, identify, lookup, etc.) the group identifier corresponding to the subset group. As another example, one or more subset groups are visible only to a creator of the corresponding subset group. In some embodiments, various group members (e.g., each group member) can separately create a subset group within the group in accordance with the preferences or requirements of the group member. In some implementations, only the group members that created the subset group within the group can determine (e.g., search, identify, lookup, etc.) the group identifiers for the corresponding subset groups.

The input content can comprise member characteristic information. In some embodiments, member characteristic information comprises information from which one or more group members of a group or a subset group can be identified. For example, member characteristic information can comprise characteristic description tags. The determined group members can comprise group members that are associated with member characteristic information pertaining to a group or a subset group. For example, the determined group members can comprise group members with which characteristic description tags are associated within the group (or subset group). The characteristic description tag can include at least one of: a self-descriptive tag (e.g., a tag pertaining to a group member that is self-added or configured by the group member), an other-descriptive tag (e.g., a tag added by another group member), a system-descriptive tag (e.g., a tag that is automatically added in accordance with information pertaining to any group member such as personal information about the any group member, past messages, historical records of operations, and data about relationships with other users, etc.), or description tags (e.g., tags that are added or associated with a group member through other channels or inputs). According to various embodiments, a characteristic description tag comprises a system preset tag or a self-defined tag. The adding of a tag can comprise associating the characteristic description tags with a corresponding group member with a group, or updating a mapping of group members to groups to associate a tag with a group member or a group, or to associate a group member with a group. According to various embodiments, mappings are stored locally at a terminal or at a server such as a server providing a service associated with a client-side application.

According to various embodiments, a characteristic description tag comprises information relating to a corresponding group member. The information relating to the group member can comprise an indication of a characteristic of the group member. For example the characteristic description tag can comprise information pertaining to a name, an alias, a gender, a position, an employer, a work department, a telephone number, a mailing address, an email address, etc., of the corresponding group member. The information pertaining to a characteristic of the group member can be self-added or configured by the group member, added or configured by another group member, added or configured by an administrator, or added or configured by the system. In some embodiments, the characteristic description tag is not specifically generated and presented in the form of a “tag.” For example, the characteristic description tag can be information stored in a mapping of information to group members or a mapping of information to groups. As an example, in response to a group member inputting personal information, such as name, telephone number, and email address into a personal information interface (e.g., provided at a client-side such as in a client-side application), the input personal information is associated with the group member and can be deemed a “characteristic description tag” of the group member. In some embodiments, the “characteristic description tag” is a “tag” that is additionally generated according to information relating to the group member. For example, the “characteristic description tag” is presented in a specific form on a specific interface (e.g., at a client-side interface such as in the client-side application) and the characteristic description tag can be added, edited, or deleted based at least in part on (e.g., and in response to) individual additions, edits, deletions, and other such maintenance operations to the specific interface with respect to a group member associated with the characteristic description tag.

According to various embodiments, characteristic description tags can be associated with more than one group member at one time. For example, information pertaining to characteristics of a plurality of group members can be obtained and associated with the plurality of group members (e.g., in the form of a characteristic description tag, etc.).

In some embodiments, the characteristic description tags are pre-added or pre-configured by the inputter of the user input content for corresponding group members. The characteristic description tags can be input contemporaneously with the input of the user input content. The characteristic description tags can be invisible to group members other than the inputter. For example, the characteristic description tags may be visible to the inputter only so as to meet the requirements or preferences of the inputter without having any effect on other group members. The characteristic description tags can be visible only to the inputter at the client-side application. For example, a user can individually characterize or configure groups or subset groups of users for group communication, and/or the user can set or define characteristic description tags for the group or subset group, or the group members thereof. In some embodiments, the characteristic description tags are visible to a plurality of group members or all the group members. For example, a group member can obtain the characteristic description tags or obtain or identify group members corresponding to the characteristic description tags and input individual notification instruction information for one or more of the group members corresponding to the characteristic description tags. The individual notification instruction information for one or more of the group members corresponding to the characteristic description tags can be input in the input box (e.g., provided at an interface of the client-side application, etc.). The look-up of one or more group members corresponding to the characteristic description tags and the input of individual notification instruction information for such one or more group members can ensure a more efficient and effective method for defining or inputting individual notification instruction information for users (e.g., group members). In some embodiments, the group members (or a plurality of group members) of one group simultaneously have characteristic description tags associated with the group members, and the characteristic description tags are visible to only some group members (e.g., the group members who added the characteristic description tags or the group members with whom the characteristic description tags are associated) or to all group members (or an otherwise defined subset of group members of the corresponding one group).

In some embodiments, the group members of a group belong to a same organization. For example, the group members can work for a same company, belong to a same social group, belong to a same department, or organizational unit within an organization such as a company, an association, a school, etc. As an example, a group can correspond to employees of a company, and a subgroup associated with the group can comprise employees of a department of the company. The member characteristic information can comprise: dimensional information comprised in (or defined by) the organizational structure of the organization. The group members of a group can comprise: group members conforming to the dimensional information within the group. For example, the dimensional information comprises at least one of: a departmental identifier, a position grade identifier, a work type identifier, and an indication of a number of years worked or a number of years of experience, etc. Therefore, when the communication is implemented using a mobile organization office platform (e.g., a client-side application and a server-side application that interface with one another), the organizational management functions of the mobile organization office platform can obtain the organizational structure of an organization. Accordingly, various embodiments can be rapidly and conveniently implemented through interactions between organizational management functions and communication functions.

In some embodiments, group members of a group belong to multiple organizations. The member characteristic information comprises: organization information, and the determined group members comprise: group members belonging to corresponding organizations within the group. In some embodiments, if the group members of the group belong to multiple organizations, the group is a trans-organizational group. By using organizational information as member characteristic information, a user can quickly reference group members of the same organization and quickly add individual notification instruction information for a group member (e.g., the referenced group members or a subset thereof) in an input box. In some embodiments, if the group members of the group belong to multiple organizations, the group members respectively belong to a plurality of groups with each group being associated with the corresponding organization to which the group members belong. Further, the use of organizational information as member characteristic information facilitates quick reference or lookup of group members of the same organization and quick notification, identification, and/or communication with the related group members.

According to various embodiments, individual notification instruction identifiers and/or member characteristic information associated with group members is manually input by a user into an interface for a client-side application or an administrator using an interface associated with a server-side application, etc.

According to various embodiments, if the user input content comprises an individual notification instruction identifier (e.g., if the terminal determines that the input content comprises the individual notification instruction identifier), an information selection interface is provided. For example, in response to determining that the user input comprises an individual notification instruction identifier, the terminal (e.g., the client-side application) displays an information selection interface. The information selection interface can comprise candidate member characteristic information. According to various embodiments, the information selection interface is provided in connection with a group communication and user input can be obtained via the information selection interface with respect to one or more group members. For example, a user can configure settings (e.g., group communication settings) pertaining to one or more group members via the information selection interface, or select the one or more group members for whom the settings are to be configured. Information selection instructions can be obtained via the information selection interface. For example, a user inputs the information selection instruction to the information selection interface (e.g., provided by the terminal by the client-side application). According to various embodiments, the information selection instruction serves as a basis to set the selected candidate member characteristic information to the member characteristic information in the user input content. For example, the user input can be obtained based at least in part on the individual notification instruction identifiers and the obtained information selection instruction. The individual notification instruction identifiers input by users (e.g., manually input by a user) and the selected member characteristic information can jointly constitute the user input content described above. Accordingly, manual input of member characteristic information as is common in the related art becomes unnecessary in various embodiments. In particular, when a large volume of member characteristic information exists, various embodiments do not require a user to remember each piece of such member characteristic information. Therefore, various embodiments lower the learning threshold for group members and facilitate rapid entry of input member characteristic information. According to various embodiments, the one or more communication session messages respectively comprise information pertaining to the input content (e.g., the user input content). For example, the one or more communication session messages respectively comprise the input content. The input content comprised in the one or more communication session messages can correspond to the input content that is input via a communication session interface provided at the terminal. The one or more communication session messages can be communicated in connection with notifying the group members of the corresponding group characteristic information within the group.

At 270, one or more communication session messages are communicated. In some embodiments, the terminal communicates the one or more communication messages to one or more other terminals. The one or more communication session messages can be sent in connection with a group communication (e.g., a group message, a group chat, etc.).

In some embodiments, the terminal communicates the one or more communication session messages to one or more recipient terminals (e.g., terminals corresponding to the intended recipient users) via a network. For example, the terminal communicates the one or more communication session messages to a server (e.g., the server running the server-side application corresponding to the client-side application running on the terminal, etc.). In response to the server receiving the one or more communication session messages or information pertaining thereto, the server determines the one or more recipient terminals to which the one or more communication session messages are to be sent and communicates the one or more communication session messages to the one or more recipient terminals via one or more networks. The server can determine one or more recipient terminals based at least in part on the input content (e.g., group characteristic information and/or member characteristic information). For example, the server can determine the one or more recipient terminals based at least in part on querying a mapping of users to groups or information pertaining to groups (e.g., group identifiers, etc.), a mapping of users or groups to member characteristic information, etc. In some embodiments the server sends the one or more communication session messages to all members comprised in the group to which the input content corresponds.

According to various embodiments, group members in the group that correspond to the member characteristic information are automatically determined according to member characteristic information comprised in the input content (e.g., user input content). The group members can be determined based at least in part on querying a mapping of member characteristic information to users (or group members), or otherwise searching for members corresponding to the member characteristic information.

According to various embodiments, a member selection interface is presented in response to a determination that input content comprises an individual notification instruction identifier. For example, in response to detecting (e.g., determining) that the user input content includes the individual notification instruction identifier, a member selection interface is provided (e.g., displayed). A client-side application can cause the terminal to display the member selection interface. The member selection interface can comprise group members matched to the user input content. For example, the member selection interface can be configured based at least in part on the group members that are determined to correspond to the input content. According to various embodiments, a member selection instruction is obtained via the member selection interface. For example, the terminal obtains the member selection instruction based at least in part on an input (e.g., by a user) to the member selection interface. In response to receiving the received member selection instruction, the group members corresponding to the member characteristic information are determined. For example, the received member selection instruction serves as a basis to determine the selected group members as the group members corresponding to the member characteristic information. In some embodiments, the member selection instruction comprises a selection of one or more group members corresponding to the user input content. For example, if the user input content is “@186,” then the member selection interface provides (e.g., displays) all the group members having a corresponding telephone number that includes “186.” Accordingly, the group members can be quickly searched for group members corresponding to the user input content. In some embodiments, one or more group members provided on the member selection interface are determined based on (e.g., in response to) a query based at least in part on the member characteristic information comprised in user input content, etc.

According to various embodiments, mappings between (or relationships of) member characteristic information and group members are used to determine corresponding member characteristic information and to determine whether the member matches the member characteristic information. For example, in response to a terminal (e.g., used by a group member that receives the one or more communication session messages) receiving the one or more communication session messages, the terminal can determine corresponding member characteristic information and determine whether the member matches the member characteristic information. In response to confirming a match, a notification for the group member is implemented. For example, the terminal for the recipient group member that receives the one or more communication session messages implements a notification corresponding to the input content. A client-side application running on the terminal for the recipient group member (e.g., a communication application) can determine that the input content comprised in the one or more communication session messages comprises an indication for configuring a notification, and in response to determining that the indication for configuring the notification is comprised in the input content, the client-side application running on the terminal for the recipient group member can set a corresponding notification (e.g., configure a corresponding notification setting).

According to various embodiments, the individual notification instruction information comprises a predefined value or character and/or an identifier of the group member. For example, the individual notification instruction information can correspond to the form of “@+member name,” etc. Other forms or formats of the individual notification instruction information can be implemented. As an example, in the case of the individual notification instruction information taking the form of “@+member name,” if “member name” is the name information for the present terminal user in a group chat message, then the group chat message can be deemed to comprise individual notification instruction information for the present terminal user. For example, in response to receiving a group chat message, a terminal can determine whether the group chat message comprises an individual notification instruction information associated with the terminal (e.g., the terminal that received the group chat message) or a user associated with the terminal. In response to determining that the group chat message comprises an individual notification instruction information associated with the terminal (e.g., the terminal that received the group chat message) or a user associated with the terminal, or that the terminal otherwise obtains (e.g., receives) the individual notification instruction information, then the terminal can perform a corresponding function, etc. As an example, the corresponding function can correspond to performing a predefined or corresponding notification. According to various embodiments, individual notification instruction information has higher notification permission. For example, the individual notification instruction information can be deemed to have a higher priority than a locally set notification setting of the terminal that receives the individual notification instruction information. If the terminal that receives the individual notification instruction information has a local setting of silent or “Do Not Disturb,” the individual notification instruction information can at least temporarily override such a setting and provide a notification (e.g., a notification set according to a sending user's preferences or settings) to the terminal (e.g., the receiving terminal). As an example of the individual notification instruction information having a higher notification permission, even if a communication session of the corresponding group has been blocked (e.g., the “Do Not Disturb” function has been activated), a corresponding message received alert can be triggered (e.g., performed), provided that the group chat message contains individual notification instruction information for the present terminal user. In embodiments, if a group chat message comprises individual notification instruction information for the present terminal user, a special received prompt is still implemented for the present terminal user. For example, to ensure that the present terminal user can notice and view the content of the group chat message, the group chat message may be continually presented through a floating window in the communication session interface of the group until the floating window is manually shut.

Accordingly, in response to a group member being notified of the input content, a corresponding message received alert can be triggered even if the group member implemented a shield (e.g., activated the “Do Not Disturb” function, or otherwise locally configured the terminal or application settings to have less intrusive notifications) in advance against a communication session of the corresponding group. In response to receiving a communication session message comprising the input content indicating that a notification is to be provided to the recipient group member (e.g., the input content comprising individual notification instruction information associated with the terminal), the notification can be provided at the recipient terminal even if the recipient terminal has a local setting configured to not have notifications provided or that is configured to have notifications be less intrusive than the notification corresponding to the input content (e.g., the individual notification instruction information). In some implementations, a special received prompt can be provided for the group member. For example, to ensure that the present terminal user can notice and view the content of the communication session message, the communication session message can be continually (or periodically) provided via a floating window in the communication session interface of the group until the floating window is manually closed.

To aid understanding, the instant messaging application “WeChat” will be used as an example in connection with describing the various embodiments. As an example, a terminal is assumed to run a WeChat client, and a server (e.g., to which the terminal can connect) is running a WeChat. The registration account of user A is logged in on the terminal (e.g., logged in to the WeChat client). The terminal is thus configured as WeChat client 1 corresponding to user A. If user A belongs to enterprise AA, enterprise AA can have a corresponding group “Enterprise AA” that exists on WeChat (e.g., on the WeChat environment). The group members of the group “Enterprise AA” are enterprise members of enterprise AA. Therefore, user A is a group member of the group “Enterprise AA.” Various embodiments can be implemented in connection with various other types of groups or environments (e.g., non-enterprise-type groups).

FIG. 3 is a diagram of a sending-side communication session interface according to various embodiments of the present application.

Referring to FIG. 3, interface 300 (e.g., for a communication application) is provided. Interface 300 can be implemented by or in connection with process 200 of FIG. 2A, process 250 of FIG. 2B, and/or computer system 1200 of FIG. 12. Interface 300 can be implemented in connection with interface 400 of FIG. 4, interface 500 of FIG. 5, interface 600 of FIG. 6A, interface 650 of FIG. 6B, interface 700 of FIG. 7A, interface 750 of FIG. 7B, interface 775 of FIG. 7C, interface 800 of FIG. 8, interface 900 of FIG. 9A, interface 950 of FIG. 9B, interface 975 of FIG. 9C, interface 1000 of FIG. 10, interface 1100 of FIG. 11A, interface 1125 of FIG. 11B, interface 1150 of FIG. 11C, interface 1175 of FIG. 11D, and/or interface 1185 of FIG. 11E.

According to various embodiments, interface 300 is provided (e.g., displayed) by a terminal. The terminal can be running a client-side application such as a communication application. In some embodiments, the client-side application communicates with a server (e.g., a server-side application running on the server). As discussed above, the client-side application can be a WeChat client. Interface 300 is further described in connection with the above-identified example of WeChat client (e.g., WeChat client 1) that is running on a terminal. The terminal can provide (e.g., display) interface 300 in connection with the running of WeChat client. For example, the WeChat client can cause the terminal to display interface 300.

Interface 300 comprises input box 310 and icon 320. Icon 320 can be a selectable element. In response to selection of icon 320, the terminal can invoke a corresponding function, etc. For example, in response to an input selecting icon 320, the client application can cause the terminal to display another interface, or to perform a corresponding function.

Information can be input to input box 310. For example, user A can input (e.g., enter) the content that user A desires to send (e.g., communicate) to one or more other users. According to various embodiments, input content is input to input box 310. In some embodiments, input box 310 is configured to receive free-form text or free-form input thereto. In some embodiments, input box 310 is configured to constrain a form or type of input thereto. For example, input box 310 can have drop-down menus or check boxes from which input to be input can be selected.

As illustrated in FIG. 3, the user input content can comprise “@Abai @Xiaobai @Beita @Liangzai @Xiaohei @Laowang @Team Leader Remember to bring one two-inch ID photo tomorrow.” The input content is input to input box 310. The input content includes content such as that in the form of “@Abai” and “@Xiaobai” For example, the input content comprises individual notification instruction information for group members (e.g., group members corresponding to “@Abai” and “@Xiaobai”). To use the example of “@Xiaobai,” the “@” is the predefined individual notification instruction identifier, and “Xiaobai” is the group member name. In some embodiments, individual notification instruction information takes the form of “@+name” or “@+group member identifier” to indicate an individual notification setting (e.g., need or requirement) for the corresponding group member.

According to various embodiments, input content (e.g., that is input to input box 310) is sent to one or more terminals or other users (e.g., group members) in response to selection of a send button (not shown) or in response to input of a predefined input (e.g., input to the “enter” button on a keyboard), etc.

In response to user A sending the user input content provided in interface 300 (e.g., the input content comprised in input box 310) to the group “Enterprise AA,” group members of the group “Enterprise AA” (e.g., all group members of the group “Enterprise AA”) will receive a communication session message comprising the input content. If the group “Enterprise AA” comprises a group member “Baibai” and the group member corresponding to “Baibai” activates a “Do Not Disturb” function for the group “Enterprise AA” (e.g., for the terminal of the group member “Baibai” with respect to interactions in the client application for the group “Enterprise AA”), then group member “Baibai” will not receive a message received alert (or other notification) in response to receiving a communication session message. The group member “Baibai” can set the “Do Not Disturb” function for the group “Enterprise AA” in order to not be disturbed (e.g., locally at the terminal used by the group member “Baibai”). In some embodiments, group member “Baibai” will not receive a message received alert with respect to a received communication session message if the communication session message does not comprise individual notification instruction information (e.g., such as “@Baibai”) for the group member “Baibai.” According to various embodiments, the notification setting configured locally at the terminal for group member “Baibai” can be overridden in connection with individual notification instruction information comprised in a received communication session message (e.g., at least with respect to the communication session message received for the group to which the individual notification instruction information is applicable or identifies).

In contrast to the receiving of the communication session message by group member “Baibai,” the case of a group member such as “Xiaobai” is different because the communication session message comprises individual notification instruction information (such as “@Xiaobai”) for the group member “Xiaobai.” Thus, in order to ensure that the group member “Xiaobai” will be able to view the corresponding communication session message and will not miss the communication message, if WeChat client 2 (which is not shown in FIG. 3) corresponding to the group member “Xiaobai” receives the aforesaid communication session message, WeChat client 2 will issue a received alert to the group member “Xiaobai” even if group member “Xiaobai” had (locally) activated the “Do Not Disturb” function for the group “Enterprise AA” (e.g., for the terminal of the group member “Xiaobai” with respect to interactions in the client application for the group “Enterprise AA”).

FIG. 4 is a diagram of a receiving-side communication session interface according to various embodiments of the present application.

Referring to FIG. 4, interface 400 (e.g., for a communication application) is provided. Interface 400 can be implemented by or in connection with process 200 of FIG. 2A, process 250 of FIG. 2B, and/or computer system 1200 of FIG. 12. Interface 400 can be implemented in connection with interface 300 of FIG. 3, interface 500 of FIG. 5, interface 600 of FIG. 6A, interface 650 of FIG. 6B, interface 700 of FIG. 7A, interface 750 of FIG. 7B, interface 775 of FIG. 7C, interface 800 of FIG. 8, interface 900 of FIG. 9A, interface 950 of FIG. 9B, interface 975 of FIG. 9C, interface 1000 of FIG. 10, interface 1100 of FIG. 11A, interface 1125 of FIG. 11B, interface 1150 of FIG. 11C, interface 1175 of FIG. 11D, and/or interface 1185 of FIG. 11E.

According to various embodiments, interface 400 is provided (e.g., displayed) by a terminal. The terminal can be running a client-side application such as a communication application. In some embodiments, the client-side application communicates with a server (e.g., a server-side application running on the server). As discussed above, the client-side application can be a WeChat client. Interface 400 is further described in connection with the above-identified example of WeChat client (e.g., WeChat client 1) that is running on a terminal. The terminal can provide (e.g., display) interface 400 in connection with the running of WeChat client. For example, the WeChat client can cause the terminal to display interface 400.

Interface 400 comprises input box communication session message 410 and notification 420.

Interface 400 is further described in the context of Group member “Xiaobai” using WeChat client 2 running on a terminal. Upon activating WeChat client 2, the user (e.g., group member “Xiaobai”) can view communication session message 410. Communication session message 410 can be displayed on interface 400. For example, the client application can display the communication session message in response to determining that the communication message is received. In some embodiments, the communication session message is pushed to the terminal (e.g., by the server), the terminal periodically polls a server for a new communication session message, or the terminal polls the new communication session message.

According to various embodiments, communication session message 410 corresponds to a message (e.g., a group message) sent by another group member (e.g., a message sent by user A). In response to receiving a new communication session message, the new communication session message may not be displayed by the terminal for group member “Xiaobai” upon receipt of the new communication session message. For example, in response to receiving the new communication session message such as the message corresponding to input content submitted to input box 310 of interface 300 of FIG. 3, the terminal for group member “Xiaobai” may not display such a communication session message (e.g., because the terminal's screen is currently turned off, the terminal's lock screen is currently displayed, the client-application is not running in the foreground of the terminal, the client-application is displaying a communication chat for another group, etc.) until the terminal (e.g., the client application) is navigated to the communication session message or the group chat window or interface for the corresponding group chat. For example, if group member “Xiaobai” did not promptly activate WeChat client 2 upon reception of the new communication session message or if the WeChat client 2 was not already configured to display the group chat for the group “Enterprise AA,” communication session message 410 (e.g., corresponding to a different group or different group chat) can be provided (e.g., displayed) in communication session interface 400, and the new communication session message is provided in response to the group member navigating to the page corresponding to the group chat (or group messages). For example, if another communication session message is received and displayed by the terminal, group member “Xiaobai” can manually switch pages to view the new communication session message. According to various embodiments, the communication session interface (e.g., interface 400) provides notification 420 in response to determining that a new communication session message is received (or is available at the server). In some embodiments, although not shown in FIG. 4, notification 420 is provided in response to determining that a new communication session message is received and/or in response to determining that the new communication session message corresponds to a group for which a group chat or group message is not presently being displayed in interface 400.

In some embodiments, and as shown in the example of FIG. 4, notification 420 pertaining to the new communication session message is provided even if the interface 400 is currently providing (e.g., displaying) a group chat or group messages for the group associated with the new communication session message. For example, as shown in the example of FIG. 4, if communication session message 410 corresponds to the new communication session message, notification 420 can be displayed on interface 400 in accordance with the individual notification instruction information associated with the communication session message 410.

According to various embodiments, settings for notifications (e.g., notifications in the client-application) can be controlled in accordance with user settings or application settings locally at the terminal. In some embodiments, settings for notifications can be controlled based at least in part on the input content comprised in the communication session message (e.g., the individual notification instruction information). In some embodiments, the settings for notifications (e.g., notifications in the client-application) are controlled according to whether input content comprised in the communication session message has priority over locally configured settings for notifications.

According to various embodiments, notification 420 is a present floating window. In some embodiments, notification 420 comprises at least a portion of the content corresponding to the new communication session message. For example, the message content of a communication session message is provided in the floating window corresponding to notification 420 without being affected by another communication session message. For example, if a new communication session message is received while the notification 420 is being provided on interface 400, interface 400 continues to display notification 420. For example, notification 420 is displayed in interface 400 until the user (e.g., group member “Xiaobai”) manually closes or disables notification 420 (e.g., selects a close button on notification 420). For example, display of notification 420 can be stopped (e.g., notification 420 can be dismissed or closed) in response to group member “Xiaobai” actively selecting the close icon “X.” In some embodiments, notification 420 disappears after being presented for a preset length of time. The preset length of time can be set according to local user settings, administrator settings, application settings, or settings comprised in the communication session message such as the input content or individual notification instruction information. In some embodiments, notification 420 is no longer displayed if the user navigates away from the group chat for the group associated with the communication session message for which notification 420 is provided. For example, if the terminal navigates to a different page such as a group chat for a group that is different from group “Enterprise AA,” then notification 420 disappears. In some embodiments, if the terminal navigates to a different page such as a group chat for a group that is different from group “Enterprise AA,” notification 420 disappears, but if the terminal re-navigates to the group chat for group “Enterprise AA,” notification 420 can be displayed again.

In the related art, in connection with adding individual notification instruction information for group members to a communication session message, a user is required to manually input the individual notification instruction information for each group member one at a time (e.g., on a group member-by-group member basis). If a group comprises a relatively large number of group members, the user may be required to add the individual notification instruction information for the relatively large number of group members. Thus, input individual notification instruction information for the group members according to the related art will be inefficient, and input errors or omissions may easily occur. In contrast, various embodiments enable addition of individual notification instruction information in an efficient and accurate manner.

FIG. 5 is a diagram of a group assignment interface for group members according to various embodiments of the present application.

Referring to FIG. 5, interface 500 (e.g., for a communication application) is provided. Interface 500 can be implemented by or in connection with process 200 of FIG. 2A, process 250 of FIG. 2B, and/or computer system 1200 of FIG. 12. Interface 500 can be implemented in connection with interface 300 of FIG. 3, interface 400 of FIG. 4, interface 600 of FIG. 6A, interface 650 of FIG. 6B, interface 700 of FIG. 7A, interface 750 of FIG. 7B, interface 775 of FIG. 7C, interface 800 of FIG. 8, interface 900 of FIG. 9A, interface 950 of FIG. 9B, interface 975 of FIG. 9C, interface 1000 of FIG. 10, interface 1100 of FIG. 11A, interface 1125 of FIG. 11B, interface 1150 of FIG. 11C, interface 1175 of FIG. 11D, and/or interface 1185 of FIG. 11E.

According to various embodiments, interface 500 is displayed in response to invocation (e.g., selection) of icon 320 provided at interface 300 of FIG. 3. For example, in response to icon 320 being invoked, the client application navigates to a page that provides interface 500. Interface 500 can be displayed in connection with the assignment or selection of group members. In some embodiments, interface 500 is provided in connection with the defining or creating of one or more subset groups associated with a group, etc.

As illustrated in FIG. 5, interface 500 comprises a group member list 510, icon 520 corresponding to a first subset group (e.g., “Project X Small Group”), icon 530 corresponding to a second subset group (e.g., “Lunch Club”), and icon 540 corresponding to the creation of a new subset group.

According to various embodiments, group member list 510 provides a list of members of a group. For example, all the group members of the group “Enterprise AA” are provided in group member list 510. Icon 520 and icon 530 can respectively correspond to selectable elements that in response to invocation (e.g., selection such as via a touch input to a touchscreen of the terminal) cause the terminal to perform a corresponding function or to navigate to a corresponding page. In some embodiments, icon 520 comprises a group identifier associated with the group to which icon 520 corresponds. For example, icon 520 comprises a group name for the first subset group (e.g., “Project X Small Group”). Similarly, in some embodiments, icon 530 comprises a group identifier associated with the group to which icon 530 corresponds. For example, icon 530 comprises a group name for the second subset group (e.g., “Lunch Club”). According to various embodiments, identifiers associated with one or more group members of the subset groups are provided on the corresponding icon displayed on interface 500 (e.g., icons 520 and 530). For example, identifiers of one or more of the group members (e.g., “Abai”) of the first subset group are comprised in icon 520. The identifiers of one or more of the group members can be a picture (e.g., a profile picture, an avatar), a name, etc.

Icons 520 and/or 530 are selectable. In response to icon 520 and/or icon 530 being invoked (e.g., selected), the terminal (e.g., client application) displays detailed information associated with the subset group corresponding to the selected icon.

According to various embodiments, the user creates a subset group comprising at least one group member of the group within which the subset group is to be created. The user can create the subset group in response to invoking a function of the terminal (e.g., the client application running on the terminal). For example, in response to selecting icon 540 corresponding to creation of a new subset group, the new subset group can be created. In some embodiments, in response to icon 540 being selected, the terminal (e.g., the client application) navigates to a new page associated with creation of a new subset group. Invoking icon 540 can cause the client application to enable the user to define the new subset group.

In some embodiments, the subset groups created in the group “Enterprise AA” are shared by all group members. If one or more subset groups are shared with all group members of the group in which the one or more subset groups are created, each member of the group can view the subset groups created by any group member (e.g., by the group member itself or another group member). In some embodiments, subset groups created by each group member are visible only to the group member that created the corresponding subset group (e.g., for the purpose of satisfying the personalized needs and preferences of the subset group creator). In such a case, other group members (e.g., those group members that did not create the subset group) will not be able to view and reference such subset groups.

According to various embodiments, one or more subset groups can be edited. In reference to the example above, user A can perform editing operations on a subset group such as the subset groups associated with icons 520 and 530. The editing operations performed with respect to a subset group can include modifying a group identifier or adding/deleting a group member belonging to the corresponding subset group. In some embodiments, only the creator of the subset group is permitted to perform the editing operations with respect to the subset group. In some embodiments, administrators (e.g., enterprise administrators) can perform editing operations with respect to a subset group created by a group member, etc. In some embodiments, other group members can be permitted to implement the editing operations with respect to a subset group (e.g., that was created by another user).

FIGS. 6A and 6B are diagrams of a type of rapid inputting of individual notification instruction information based on groupings according to various embodiments of the present application.

Referring to FIGS. 6A and 6B, interface 600 and interface 650 are provided. Interface 600 and/or interface 650 can be implemented by or in connection with process 200 of FIG. 2A, process 250 of FIG. 2B, and/or computer system 1200 of FIG. 12. Interface 600 and/or interface 650 can be implemented in connection with interface 300 of FIG. 3, interface 400 of FIG. 4, interface 500 of FIG. 5, interface 700 of FIG. 7A, interface 750 of FIG. 7B, interface 775 of FIG. 7C, interface 800 of FIG. 8, interface 900 of FIG. 9A, interface 950 of FIG. 9B, interface 975 of FIG. 9C, interface 1000 of FIG. 10, interface 1100 of FIG. 11A, interface 1125 of FIG. 11B, interface 1150 of FIG. 11C, interface 1175 of FIG. 11D, and/or interface 1185 of FIG. 11E.

As shown in FIG. 6A, interface 600 comprises input box 610 and selection interface 620. In response to input of an individual notification instruction identifier into input box 610, selection interface 620 is provided (e.g., displayed). For example, in response to an input to input box 610, the client application determines whether the input corresponds to (or comprises) an individual notification instruction identifier. The client application can poll for an input to input box 610 (e.g., to detect the input to input box 610) and in response to determining that an input to input box 610 is input, selection interface 620 is invoked. As an example, if user A inputs an individual notification instruction identifier such as “@” in input box 610 within interface 600 (e.g., communication session interface corresponding to user A), the selection interface 620 is displayed. Selection interface 620 can comprise a list of groups that have been defined. For example, selection interface 620 can comprise an indication of subset groups that have been created (e.g., such as “Project X Small Group,” which is the name of subset group 520 and “Lunch Club,” which is the name of subset group 530, as described above). Selection interface 620 can provide elements corresponding to defined groups (e.g., defined subset groups) that can be selected. Selection interface 620 can provide group identifiers corresponding to one or more defined groups (e.g., subset groups). As an example, if the terminal determines that an input is made with respect to a group identifier (e.g., in response to determining that the user selected the group identifier “Project X Small Group” corresponding to subset group 520), then WeChat client 1 can determine (e.g., generate) corresponding individual notification instruction information for one or more of the group members belonging to the group corresponding to the selected group identifier. In some implementations, the individual notification instruction information is determined for each group member belonging to the group corresponding to the selected group identifier. As an example, if the group identifier for “Project X Small Group” corresponding to subset group 520 of FIG. 5 is selected, group members of the subset group having the group identifier “Project X Small Group” are used to generate corresponding individual notification instruction information. The seven group members belonging to corresponding subset group 520 are used to generate corresponding individual notification instruction information (e.g., “@Abai @Xiaobai @Beita @Liangzai @Xiaohei @Laowang @Team Leader”). For example, an individual notification instruction for each of the seven group members is generated.

As illustrated in FIG. 6B, interface 650 is provided. Interface 650 comprises input box 610. In response to the determination that an input is made with respect to a group identifier (e.g., in response to determining that the user selected the group identifier “Project X Small Group” corresponding to subset group 520) in the selection interface 620 of interface 600, a corresponding individual notification instruction information is determined for each group member belonging to the group corresponding to the selected group identifier, and the corresponding individual notification instruction information for each group member belonging to the group corresponding to the selected group identifier is added (e.g., by the client-side application) to input box 610. For example, the generated individual notification instruction information for each group member belonging to the group corresponding to the selected group identifier is added to input box 610 without user A having to manually input the individual notification instruction information (e.g., user A is not required to add the individual notification instruction information one at a time).

Although selection interface 620 takes the form of a window in communication session interface 600 of FIG. 6A, selection interface 620 can take the form of an independent interface (e.g., the client application can be directed to or otherwise navigated to a different page). As an example, if the terminal has a relatively small screen, providing the selection interface 620 in the form of a window may obstruct such a large portion of interface 600 that the interface 600 becomes difficult for the user to use. Accordingly, the client-side application can switch from communication session interface 600 to selection interface 620 for user A to select the group identifiers that are of interest.

FIGS. 7A through 7C are diagrams of a type of rapid inputting of individual notification instruction information based on groupings according to various embodiments of the present application.

Referring to FIGS. 7A through 7C, interface 700, interface 750, and interface 775 are provided. Interface 700, interface 750, and interface 775 can be implemented by or in connection with process 200 of FIG. 2A, process 250 of FIG. 2B, and/or computer system 1200 of FIG. 12. Interface 700, interface 750, and interface 775 can be implemented in connection with interface 300 of FIG. 3, interface 400 of FIG. 4, interface 500 of FIG. 5, interface 600 of FIG. 6A, interface 650 of FIG. 6B, interface 800 of FIG. 8, interface 900 of FIG. 9A, interface 950 of FIG. 9B, interface 975 of FIG. 9C, interface 1000 of FIG. 10, interface 1100 of FIG. 11A, interface 1125 of FIG. 11B, interface 1150 of FIG. 11C, interface 1175 of FIG. 11D, and/or interface 1185 of FIG. 11E.

As illustrated in FIGS. 7A and 7C, interface 700 and interface 775 comprise an input box 710 into which input content is input. As illustrated in FIG. 7B, interface 750 comprises a selection interface.

Selection interface 750 can be provided in response to determining that an input to interface 700 invokes the selection interface. In some embodiments, an input to interface 700 can invoke selection interface 750 if the input corresponds to a predefined input. For example, in response to a determination that the input to interface 700 comprises an individual notification instruction, selection interface 750 is invoked. In response to determining that the selection interface is invoked, the client-side application provides (e.g., is directed or navigated to) selection interface 750. For example, the client-side application navigates from a communication interface such as interface 700 to selection interface 750 at which one or more groups are selected (e.g., by the user). Selection interface 750 can comprise a list of groups that have been defined. For example, selection interface 750 can comprise an indication of subset groups that have been created (e.g., such as “Project X Small Group,” which is the name of subset group 520 and “Lunch Club,” which is the name corresponding to subset group 530, as described above). Selection interface 750 can provide elements corresponding to defined groups (e.g., defined subset groups) that can be selected. Selection interface 750 can provide group identifiers corresponding to one or more defined groups (e.g., subset groups). As an example, if the terminal determines that an input is made with respect to a group identifier (e.g., in response to determining that the user selected the group identifier “Project X Small Group” corresponding to subset group 520), then WeChat client 1 can determine (e.g., generate) corresponding individual notification instruction information for one or more of the group members belonging to the group corresponding to the selected group identifier. In some implementations, the individual notification instruction information is determined for each group member belonging to the group corresponding to the selected group identifier. As an example, if the group identifier for “Project X Small Group” corresponding to subset group 520 of FIG. 5 is selected, group members of the group having the group identifier “Project X Small Group” are used to generate corresponding individual notification instruction information. The seven group members belonging to corresponding subset group 520 are used to generate corresponding individual notification instruction information (e.g., “@Abai @Xiaobai @Beita @Liangzai @Xiaohei @Laowang @Team Leader”). For example, an individual notification instruction information for each of the seven group members is generated.

According to various embodiments, the terminal (e.g., the client-side application) provides the selection interface 750 of FIG. 7B in response to the selection interface being invoked. The selection interface can be invoked in response to determining that a predefined individual notification instruction identifier is input to the client-side application. For example, in response to determining that the predefined individual notification instruction identifier is input to the input box of the communication interface (e.g., input box 710 of interface 700), the selection interface 750 is provided.

As an example, selection interface 750 of FIG. 7B is displayed in response to detecting input (e.g., by user A) of an individual notification instruction identifier such as “@” in input box 710 within communication session interface 700 corresponding to user A, as shown in FIG. 7A. The selection interface 750 can provide predefined (e.g., already created) subset groups, such as “Project X Small Group,” which is the group identifier corresponding to icon 520 of interface 500 of FIG. 5, and “Lunch Club,” which is the group identifier corresponding to icon 530 of interface 500 of FIG. 5. If selection (e.g., by the user) of the group identifier “Project X Small Group” corresponding to a subset group is selected, then WeChat client 1 generates individual notification instruction information for one or more group members of the subset group. For example, the client application generates individual notification instruction information for each group member of the subset group. As an example, if the group identifier for “Project X Small Group” corresponding to subset group 520 of FIG. 5 is selected, group members of the group having the group identifier “Project X Small Group” are used to generate corresponding individual notification instruction information. The seven group members belonging to corresponding subset group 520 are used to generate corresponding individual notification instruction information (e.g., “@Abai @Xiaobai @Beita @Liangzai @Xiaohei @Laowang @Team Leader”). As an example, an individual notification instruction information for each of the seven group members is generated. According to various embodiments, in response to a determination that an input is made with respect to a group identifier (e.g., in response to determining that the user selected the group identifier “Project X Small Group” corresponding to subset group 520) in the selection interface 620, a corresponding individual notification instruction information is determined for each group member belonging to the group corresponding to the selected group identifier, and the corresponding individual notification instruction information for each group member belonging to the group corresponding to the selected group identifier is added (e.g., by the client-side application) to input box 710. As illustrated in FIG. 7C, the corresponding individual notification instruction information for each group member belonging to the group corresponding to the selected group identifier is added to input box 710 of interface 775 (e.g., communication interface).

FIG. 8 is a diagram of a type of editing of group member characteristic description tags according to various embodiments of the present application.

Referring to FIG. 8, interface 800 (e.g., for a communication application) is provided. Interface 800 can be implemented by or in connection with process 200 of FIG. 2A, process 250 of FIG. 2B, and/or computer system 1200 of FIG. 12. Interface 800 can be implemented in connection with interface 300 of FIG. 3, interface 400 of FIG. 4, interface 500 of FIG. 5, interface 600 of FIG. 6A, interface 650 of FIG. 6B, interface 700 of FIG. 7A, interface 750 of FIG. 7B, interface 775 of FIG. 7C, interface 900 of FIG. 9A, interface 950 of FIG. 9B, interface 975 of FIG. 9C, interface 1000 of FIG. 10, interface 1100 of FIG. 11A, interface 1125 of FIG. 11B, interface 1150 of FIG. 11C, interface 1175 of FIG. 11D, and/or interface 1185 of FIG. 11E.

As illustrated in FIG. 8, interface 800 comprises a plurality of group member characteristic description tags. For example, interface 800 comprises tag 810, tag 820, tag 830, and/or element 840.

Interface 800 of FIG. 8 is further described in connection with the example of group member “Xiaobai.” The user A can select group member “Xiaobai” at an interface provided in the client-side application. In response to determining that group member “Xiaobai” is selected, the terminal can open a personal information interface (e.g., interface 800) corresponding to group member “Xiaobai.” For example, in response to determining that an input is received with respect to selection of group member “Xiaobai,” the client-side application is directed or navigated to interface 800 corresponding to a personal information interface. The personal information interface (e.g., interface 800) shows one or more characteristic description tags corresponding to the group member “Xiaobai.” For example, the terminal can query a mapping of characteristic description tags to group members in connection with populating the personal information interface. As another example, a page specifically including characteristic description tags for the corresponding group member (e.g., the specific group member selected) can be provided to the terminal by a server (e.g., the server-side application).

According to various embodiments, the characteristic description tags of group member “Xiaobai” include tag 810, “Department A.” Tag 810 can be determined based at least in part on the organizational structure of enterprise AA. For example, the WeChat server can programmatically determine the tag 810. In some embodiments, a mapping of tags to the organizational structure of enterprise AA and/or a mapping of group members to the organizational structure of enterprise AA is queried in connection with determining tag 810. If group member “Xiaobai” belongs to Department A within the organizational structure, the WeChat server can programmatically generate the tag 810 for group member “Xiaobai” and the WeChat server can programmatically provide the tag 810 to the client-side application (e.g., the terminal).

According to various embodiments, the characteristic description tags of group member “Xiaobai” include tag 820, “Active.” Tag 820 can be determined based at least in part on the historical information corresponding to the group member. For example, the WeChat server can programmatically determine the tag 820. In some embodiments, a mapping of tags to historical information about group member “Xiaobai” is queried in connection with determining tag 820. In some embodiments, if the number of daily messages issued within the group “Enterprise AA” by group member “Xiaobai” attains or exceeds a preset number, the group member “Xiaobai” can be programmatically deemed to belong to the “Active” type. In some embodiments, a group member is programmatically deemed to correspond to the “Active” type if a time between a current time and a last sent message or last input of the client-side application, the last login to the client-side application, etc., is less than a predefined threshold amount of time.

According to various embodiments, the characteristic description tags of group member “Xiaobai” include tag 830, “Bai Family.” Tag 830 can be self-defined and added by group member “Xiaobai” or added by user A.

According to various embodiments, element 840 is a selectable element. In response to element 840 being selected or invoked, a corresponding function is performed. In some embodiments, in response to element 840 being selected, a group member characteristic description tag can be added (e.g., created and/or defined). For example, in response to element 840 being selected, an interface or other element is provided with which a new group member characteristic description tag is added.

In some embodiments, group member “Xiaobai” may self-add or edit characteristic description tags.

In some embodiments, if characteristic description tags are added, the tag content available for selection by the user A is fixed content pre-determined by the WeChat server. In some embodiments, other tag information or characteristics, or tag content can be self-defined by user A and other tag adders.

According to various embodiments, the characteristic description tags programmatically added by the WeChat server cannot be subjected to user A operations. For example, a user cannot edit or delete a characteristic description tag that is programmatically added by the WeChat server. In some embodiments, self-added tags, such as tag 830, or tags added by other group members, can be modified (e.g., by selecting the corresponding tag such as tag 830 to modify the tag content thereof) or deleted (e.g., by selecting the deletion option “X” displayed on tag 830) by user A.

According to various embodiments, the characteristic description tags programmatically added by the WeChat server are visible to all group members. Characteristic description tags are thus shared among group members. In some embodiments, characteristic description tags added by a group member or user are visible to one or more other group members of the same group or to other users. For example, if tag 830 was created by user A, tag 830 is visible to user A alone so as to meet the personalized needs and preferences of user A. A characteristic description tag added by another user or other group member can be invisible to group members that are not the creator of the tag (e.g., group member “Xiaobai”) in order to prevent too many characteristic description tags from adversely affecting use (e.g., to prevent obscurity through an excessively large number of tags).

FIGS. 9A through 9C are diagrams of a type of rapid inputting of individual notification instruction information based on characteristic description tags according to various embodiments of the present application.

Referring to FIGS. 9A through 9C, interfaces 900, 950, and 975 (e.g., for a communication application) are provided. Interfaces 900, 950, and 975 can be implemented by or in connection with process 200 of FIG. 2A, process 250 of FIG. 2B, and/or computer system 1200 of FIG. 12. Interfaces 900, 950, and 975 can be implemented in connection with interface 300 of FIG. 3, interface 400 of FIG. 4, interface 500 of FIG. 5, interface 600 of FIG. 6A, interface 650 of FIG. 6B, interface 700 of FIG. 7A, interface 750 of FIG. 7B, interface 775 of FIG. 7C, interface 800 of FIG. 8, interface 1000 of FIG. 10, interface 1100 of FIG. 11A, interface 1125 of FIG. 11B, interface 1150 of FIG. 11C, interface 1175 of FIG. 11D, and/or interface 1185 of FIG. 11E.

As shown in FIG. 9A, communication session interface (e.g., interface 900) comprises input box 910. In response to an input being input to input box 910, the terminal (e.g., the client-side application) determines whether the input includes or otherwise corresponds to an individual notification instruction identifier. In some embodiments, in response to determining that the input to the input box 910 comprises or otherwise corresponds to an individual notification instruction identifier, the terminal (e.g., the client-side application) determines whether a characteristic description tag is input in connection with the individual notification instruction identifier. In response to determining that the characteristic description tag is input in connection with the individual notification instruction identifier, corresponding individual notification instruction information is generated for one or more of the group members. In some embodiments, the corresponding individual notification instruction information for each group member belonging to the group corresponding to the selected group identifier is generated. As an example, if the terminal determines that user A has entered “@Bai Family” in input box 910, if the symbol “@” is predefined as an individual notification instruction identifier, and if “Bai Family” is predefined as a characteristic description tag, then the individual notification instruction identifier and the characteristic description tag can be used in connection with generating corresponding individual notification instruction information for all group members to which the characteristic description tag “Bai Family” has been added and to automatically add the individual notification instruction information (e.g., “@Abai @Baibai @Xiaobai @Baicai @Henbaibdebai @Xiaohei,” as shown in FIG. 10) to input box 910. For example, the individual notification instruction information corresponding to each group member associated with the specified characteristic description tag of “BaiFamily” can be added to input box 910 without user A having to manually enter the individual notification instruction information (e.g., one identifier at a time). In some embodiments, the individual notification instruction information can be added as metadata to input box 910 or to the input content such that the individual notification instruction information is not visible to a user (e.g., unless the user selects the input content such as via a click operation or a hovering operation). As an example, an individual notification instruction information for each of the group members is generated.

As illustrated in FIG. 9B, interface 950 comprises input box 910, cursor 920, and notification 930. In some embodiments, if user A selects “@Bai Family” that is input to input box 910 of interface FIG. 9A, notification 930 is provided. The input to input box 910 can be selected based on a click operation or a hovering of 920 as illustrated in FIG. 9B. For example, as illustrated in FIG. 9B, hovering of the cursor 920 over “@Bai Family,” which is input to input box 910, the client application (e.g., WeChat client 1) can invoke display of notification 930. Notification 930 can correspond to a present temporary window. According to various embodiments, notification 930 can comprise information indicating group members associated with the input content (e.g., the group members “@Abai @Baibai @Xiaobai @Baicai @Henbaibdebai @Xiaohei,” which are matched to “@Bai Family,” are displayed in a temporary window). According to various embodiments, the selection of the input to input box 910 can invoke display of information pertaining to the generated individual notification instruction information. Accordingly, content displayed in input box 910 can thus be simplified in the context shown in FIG. 9A, and the user's need to obtain detailed information associated with the input content can also be satisfied (e.g., via display of notification 930).

According to various embodiments, if user A inputs the individual notification instruction identifier “@” a selection interface is invoked and displayed to user A, and user A is presented with candidate characteristic description tags. Fast batch input of individual notification instruction information is thus implemented according to the characteristic description tag selected by user A. In some embodiments, in response to determining that user A inputs “@ Project X Small Group,” the individual notification instruction identifier “@” and the subset group identifier “Project X Small Group,” which are contained therein, serve as a basis for rapid batch input of individual notification instruction information.

According to various embodiments, if input content (e.g., that is input by user A) comprises individual notification instruction identifiers and characteristic description tags, the characteristic description tags can be used in connection with determining the corresponding group members. Accordingly, input content can serve as at least part of the individual notification instruction information for the corresponding group members without the user input content having to be replaced with individual notification instruction information for each of the corresponding group members. For example, if the input content is “@Bai Family,” the input content includes the notification instruction identifier “@” and the characteristic description tag “Bai Family,” which may be directly displayed as the “@Bai Family,” as illustrated in FIG. 9A, without having to replace “@Bai Family” with “@Abai @Baibai @Xiaobai @Baicai @Henbaibdebai @Xiaohei.” For example, the client-application can determine that the input content comprises “@Bai Family” (e.g., an individual notification instruction identification) and associate the individual notification instruction information for the corresponding group members but continue to display the input content without specifically displaying the individual notification instruction information in the input box 910. Similarly, with respect to interfaces illustrated in FIGS. 6A and 6B and FIGS. 7A through 7C, “@Project X Small Group” can be displayed directly without having to display the individual notification instruction information for each group member as “@Abai @Xiaobai @Beita @Liangzai @Xiaohei @Laowang @Team Leader.” The display of user input content (e.g., without generating display of the individual notification instruction information for each group member) may prevent excessively long user input content and help improve efficiency of user information acquisition, particularly if a relatively large number of corresponding group members exist.

According to various embodiments, if after viewing the detailed content displayed in notification 930 based on the operation described above, user A wishes to adjust the detailed content, user A can perform an editing operation such as adding or deleting the detailed content by triggering (e.g., selecting) the corresponding input content (e.g., “@Bai Family”) or notification 930, without having to repeat the input process described above.

As illustrated in FIG. 9C, interface 975 comprises input box 910, message 940, notification 950, and cursor 922. Message 940 can be displayed in response to a message being sent or received. For example, in response to determining that a new message has been sent, or that a new message has been received, with respect to the communication of the interface 975, the corresponding message 940 is displayed. According to various embodiments, if interface 975 corresponds to an interface for a specific group chat or group communication (e.g., a communication for one or more specific groups or subset groups), then only sent and received messages pertaining to that group chat or group communication are displayed in interface 975.

As illustrated in FIG. 9C, after user A issues (e.g., sends) a communication message, WeChat client 1 can display message 940 corresponding to the sent message in interface 900 (e.g., the communication session interface). For example, the content of sent message 940 is “@Bai Family Let's get together for dinner after work today, at the same restaurant as last time,” and it comprises “@Bai Family” as shown in FIGS. 9A and 9B. In some embodiments, if “@Bai Family” comprised in message 940 is triggered (e.g., selected such as via a click operation or a hovering operation), notification 950 is displayed. For example, if a user selects “@Bai Family” in message 940 (e.g., via a click operation, a touch input, or a hovering of cursor 922 with respect to “@Bai Family”), WeChat client 1 generates and/or provides notification 950. Notification 950 can comprise information indicating group members associated with the input content (e.g., the group members “@Abai @Baibai @Xiaobai @Baicai @Henbaibdebai @Xiaohei,” which are matched to “@Bai Family,” are displayed in a temporary window). Similarly, after other group members in the group receive the corresponding communication message, the other group members can cause the WeChat clients used to display the corresponding communication message to display the information indicating group members associated with the input content (e.g., the group members “@Abai @Baibai @Xiaobai @Baicai @Henbaibdebai @Xiaohei,” which are matched to “@Bai Family,” are displayed in temporary window).

FIG. 10 is a diagram of a type of rapid inputting of individual notification instruction information based on characteristic description tags according to various embodiments of the present application.

Referring to FIG. 10, interface 1000 (e.g., for a communication application) is provided. Interface 1000 can be implemented by or in connection with process 200 of FIG. 2A, process 250 of FIG. 2B, and/or computer system 1200 of FIG. 12. Interface 1000 can be implemented in connection with interface 300 of FIG. 3, interface 400 of FIG. 4, interface 500 of FIG. 5, interface 600 of FIG. 6A, interface 650 of FIG. 6B, interface 700 of FIG. 7A, interface 750 of FIG. 7B, interface 775 of FIG. 7C, interface 800 of FIG. 8, interface 900 of FIG. 9A, interface 950 of FIG. 9B, interface 975 of FIG. 9C, interface 1100 of FIG. 11A, interface 1125 of FIG. 11B, interface 1150 of FIG. 11C, interface 1175 of FIG. 11D, and/or interface 1185 of FIG. 11E.

As illustrated in FIG. 10, interface 1000 comprises input box 1010. Input content is input to input box 1010. In response to determining that input content is input to input box 1010 or in response to determining that the input box 1010 comprises input content, the terminal can determine whether the input content comprises an individual notification instruction identifier in connection with a characteristic description tag. According to various embodiments, in response to determining that the input content comprises an individual notification instruction identifier in connection with a characteristic description tag, the individual notification instruction identifier and the characteristic description tag can be used in connection with generating corresponding individual notification instruction information for one or more (or all) group members to which the characteristic description tag has been added. In response to the generating of the individual notification instruction information, the individual notification instruction information is associated with the input content. However, the individual notification instruction information can be associated with the input content in a manner that the individual notification instruction information is not displayed in the input box 1010.

FIGS. 11A through 11D are diagrams of a type of rapid inputting of individual notification instruction information based on characteristic description tags according to various embodiments of the present application.

Referring to FIGS. 11A through 11D, interface 1100, interface 1125, interface 1150, and interface 1175 (e.g., for a communication application) are provided. Interface 1100, interface 1125, interface 1150, and/or interface 1175 can be implemented by or in connection with process 200 of FIG. 2A, process 250 of FIG. 2B, and/or computer system 1200 of FIG. 12. Interfaces 1100, interface 1125, interface 1150, and/or interface 1175 can be implemented in connection with interface 300 of FIG. 3, interface 400 of FIG. 4, interface 500 of FIG. 5, interface 600 of FIG. 6A, interface 650 of FIG. 6B, interface 700 of FIG. 7A, interface 750 of FIG. 7B, interface 775 of FIG. 7C, interface 800 of FIG. 8, interface 900 of FIG. 9A, interface 950 of FIG. 9B, interface 975 of FIG. 9C, and/or interface 1000 of FIG. 10.

As illustrated in FIG. 11A, interface 1100 comprises input box 1110 and selection interface 1120.

The characteristic description tags illustrated in FIG. 11A differ from the specially created and maintained tags such as tag 810, tag 820, and tag 830 of FIG. 8. For example, the characteristic tags of FIG. 11A correspond to group member personal information. The group member personal information can be used in connection with characteristic description tags so as to implement rapid input of individual notification instruction information. As an example, the group member personal information can comprise an email, an address, a phone number, a zip code, a social security number, etc. FIGS. 11A, 11B, and 11C are described in the context of the group member personal information corresponding to a telephone number respectively associated with the member.

As illustrated in FIG. 11A, interface 1100 comprises an input box 1110. Input content is input into input box 1110. In response to determining that input content is input to input box 1110 or in response to determining that the input box 1110 comprises input content, the terminal can determine whether the input content comprises an individual notification instruction identifier in connection with a characteristic description tag. According to various embodiments, in response to determining that the input content comprises an individual notification instruction identifier in connection with a characteristic description tag, the individual notification instruction identifier and the characteristic description tag can be used in connection with generating corresponding individual notification instruction information for one or more (or all) group members to which the characteristic description tag has been added. In response to the generating of the individual notification instruction information, the individual notification instruction information is associated with the input content. However, the individual notification instruction information can be associated with the input content in a manner that the individual notification instruction information is not displayed in the input box 1110.

In some embodiments, in response to determining that the input to the input box 1110 comprises or otherwise corresponds to an individual notification instruction identifier, the terminal (e.g., the client-side application) determines whether a characteristic description tag is input in connection with the individual notification instruction identifier. In response to determining that a characteristic description tag is input in connection with the individual notification instruction identifier, corresponding individual notification instruction information is generated for one or more of the group members associated with the input characteristic description tag. In some embodiments, the corresponding individual notification instruction information for each group member belonging to the group corresponding to the input characteristic description tag is generated. As an example, if the terminal determines that user A has entered the input “@186” to input box 1110 at the communication session interface corresponding to user A, the client-side application can determine group member personal information based at least in part on the member characteristic information. According to various embodiments, the character “@” is an individual notification instruction identifier, and the member characteristic information is “186.”

According to various embodiments, the group member personal information can be determined based at least in part on the member characteristic information obtained from the input (e.g., the input content) to the input box 1110. For example, a query of a mapping of member characteristic information to group member personal information, or a query of a mapping of member characteristic information to users (or members) can be performed in connection with determining the group member personal information corresponding to the member characteristic information obtained from the input (e.g., the input content) to the input box 1110. In some embodiments, the client-side application running on the terminal determines the group member personal information corresponding to the member characteristic information. In some embodiments, the server-side application running on a server determines the group member personal information corresponding to the member characteristic information.

As an example, in response to determining that the input box 1110 comprises the input “@186,” WeChat client 1 uses the member characteristic information “186” to search group member personal information. A search can be conducted within “telephone numbers” of group members (e.g., a mapping of telephone numbers to users can be queried). According to various embodiments, in response to determining the group member personal information corresponding to the member characteristic information, a selection interface is invoked. As illustrated in FIG. 11A, selection interface 1120 can be displayed on interface 1100. The selection interface 1120 displays the search results comprising the group members having a telephone number that includes “186” (e.g., selection interface 1120 of FIG. 11A includes group members Xiaobai, Liuge, Team Leader, and Liangzai, each of whom have a telephone number starting with the three digits “186”). As another example, the results provided in the selection interface 1120 include one or more group members having a telephone number including the number “186” in any set of digits thereof. For example, as illustrated in FIG. 11A, selection interface 1120 further includes the group member Liangzai who has a telephone number including “186” in any three digits. In some embodiments, the selection interface 1120 individually displays the name and telephone number of each group member in the search results (or a set of the group members having a telephone number including the number “186”). In some embodiments, the selection interface 1120 comprises a predefined number of results or a set of results not to exceed a threshold number of results

According to various embodiments, one or more of the group members provided in the results displayed in the selection interface 1120 can be selected. In some embodiments, individual notification instruction information is generated for each of the one or more group members provided in the selection interface 1120 that are selected. For example, if user A selects a group member of interest, individual notification instruction information is generated for such group member. As an example, the individual notification instruction information “@Xiao Bai” is generated for group member Xiaobai in response to selection of the group members in the selection interface 1120 (“Xiaobai (18646325287)).” According to various embodiments, the individual notification instruction information is provided in the input box 1110. For example, in response to generating the individual notification instruction information, the input box 1110 is populated with at least the individual notification instruction information.

According to various embodiments, the selection interface 1120 comprises an item for an option to select all the resulting group members. For example, selection interface 1120 displays the “@All of the below” option as shown in FIG. 11A. In response to selection of the option for selecting all the resulting group members, individual notification instruction information corresponding to each of the group members in the results provided in the display interface 1120 (or that result from the query used to populate the selection interface 1120, or a portion of such results) is generated. In one example, in response to determining that user A selected the “@All of the below” option, WeChat client 1 automatically generates individual notification instruction information corresponding to the four group members of the search results (e.g., @Xiaobai @Liuge @Team Leader @Liangzai, as shown in interface 1125 of FIG. 11B). The individual notification instruction information corresponding to each of the group members in the results provided in the display interface 1120 (or that result from the query used to populate the selection interface 1120, or a portion of such results) are added to the input box on the interface. For example, in response to generating the individual notification instruction information corresponding to the four group members of the search results (e.g., @Xiaobai @Liuge @Team Leader @Liangzai, as shown in FIG. 11B), the individual notification instruction information is added to input box 1110. According to various embodiments, the individual notification instruction information is added to input box 1110 without user A having to manually input the individual notification instruction information (e.g., one at a time such as on a group member-by-group member basis).

According to various embodiments, in response to selection of the “@All of the below,” the group members having group member personal information that corresponds to the member characteristic information are added (e.g., displayed) in the input box. As an example, in response to determining that user A selected the “@All of the below” option provided in the selection interface 1120, as illustrated in interface 1150 of FIG. 11C, “@Members whose telephone number contains 186” is provided in input box 1110 to represent the aforesaid “@Xiaobai @Liuge @Team Leader @Liangzai.” In some embodiments, in response to selection of the “@Members whose telephone number contains 186” (e.g., via a click operation, a touch input, a hovering of a cursor over “@Members whose telephone number contains 186” option, etc.), the detailed information (e.g., contents) including “@Xiaobai @Liuge @Team Leader @Liangzai” is temporarily displayed (e.g., provided in a floating window, etc.). In some embodiments, the detailed content is editable. Accordingly, various embodiments simplify the display and editing of information while also meeting the need for detailed content.

According to various embodiments, one or more group members provided in the selection interface 1120 can be selected (e.g., by the user). For example, the user can select a plurality of group members for whom the individual notification instruction information is generated. As an example, as illustrated in interface 1175 of FIG. 11D, if user A wishes to select multiple group members, but not all group members, selection interface 1120 includes “Select” and “Deselect” options to use in connection with selecting the one or more group members for whom the individual notification instruction information is to be generated. In response to determining that the “Select” option is selected (e.g., selection of the “Select” option by user A is detected), user A is permitted to select multiple group members in selection interface 1120. If a majority of the group members provided in the selection interface 1120 are to be selected, user A can select those group members who are not to receive individual notifications by invoking (e.g., selecting) the “Deselect” option. In response to determining that the “Deselect” option is invoked (e.g., selected), individual notification instruction information is generated for the group members that are not selected. For example, in response to determining that the “Deselect” option is invoked (e.g., selected), WeChat client 1 generates corresponding individual notification instruction information with respect to the group members that were not selected.

In addition, similar to the interfaces shown in FIGS. 7A through 7C, selection interface 1120 shown in FIG. 11A can be presented in the form of an independent interface. For example, in response to determining that an individual notification instruction identifier such as “@” is input (e.g., by user A) in input box 710 shown in FIG. 7A, the selection interface shown in FIG. 7B is displayed. Furthermore, if a response to determining that an input (e.g., by user A) of the member characteristic information “186” is obtained (e.g., detected) in the search box, a search based on this member characteristic information “186” within group member personal information is performed. For example, the client-side application performs a query of a mapping of group member personal information to users, etc. As an example, in response to determining that an input (e.g., by user A) of the member characteristic information “186” is obtained (e.g., detected) in the search box, WeChat client 1 conducts a search based on the member characteristic information “186” within group member personal information. Similarly, as illustrated in FIG. 11E, a search can be performed based at least in part on a telephone number, or other personal information. As illustrated in FIG. 11E, a search is conducted within telephone numbers of group members in response to a search query being input to interface 1185 (e.g., selection interface). In response to determining that the search query is obtained (e.g., to the interface 1185), a query is performed based at least in part on the search query and/or a mapping of telephone numbers to users or group members. In response to obtaining search results to the query, the search results are displayed on interface 1185. For example, the search results are provided on the selection interface. As an example, the search results comprise group members whose telephone numbers include “186.” As illustrated in FIG. 11E, group members Xiaobai, Liuge, and Team Leader, whose telephone numbers start with the three digits “186,” are displayed. Further examples include any group member, such as Liangzai, whose telephone number has “186” in any three digits. According to various embodiments, the name and telephone number of each group member in the search results are individually displayed with “186” in the telephone numbers. The portion of the search results corresponding to the search query can be displayed emphatically (e.g., the “186” in the telephone numbers is shown underlined in FIG. 11E) for easier viewing by user A. Accordingly, user A can select one or more group members of interest or may select all group members (i.e., the group members Xiaobai, Liuge, Team Leader, and Liangzai shown in FIG. 11E) of the search results by selecting “All of the below.” WeChat client 1 can automatically generate the corresponding individual notification instruction information without user A having to input them manually one at a time.

FIG. 12 is a functional diagram of a computer system for communication according to various embodiments of the present application.

Referring to FIG. 12, system 1200 for communication is provided. Computer system 1200 can implement system 100 of FIG. 1, process 200 of FIG. 2A, process 250 of FIG. 2B, interface 300 of FIG. 3, interface 400 of FIG. 4, interface 500 of FIG. 5, interface 600 of FIG. 6A, interface 650 of FIG. 6B, interface 700 of FIG. 7A, interface 750 of FIG. 7B, interface 775 of FIG. 7C, interface 800 of FIG. 8, interface 900 of FIG. 9A, interface 950 of FIG. 9B, interface 975 of FIG. 9C, interface 1000 of FIG. 10, interface 1100 of FIG. 11A, interface 1125 of FIG. 11B, interface 1150 of FIG. 11C, interface 1175 of FIG. 11D, and/or interface 1185 of FIG. 11E.

Computer system 1200, which includes various subsystems as described below, includes at least one microprocessor subsystem (also referred to as a processor or a central processing unit (CPU)) 1202. For example, processor 1202 can be implemented by a single-chip processor or by multiple processors. In some embodiments, processor 1202 is a general purpose digital processor that controls the operation of the computer system 1200. Using instructions retrieved from memory 1210, the processor 1202 controls the reception and manipulation of input data, and the output and display of data on output devices (e.g., display 1218).

Processor 1202 is coupled bi-directionally with memory 1210, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1202. Also as is well known in the art, primary storage typically includes basic operating instructions, program code, data, and objects used by the processor 1202 to perform its functions (e.g., programmed instructions). For example, memory 1210 can include any suitable computer-readable storage media, described below, depending on whether, for example, data access needs to be bi-directional or uni-directional. For example, processor 1202 can also directly and very rapidly retrieve and store frequently needed data in a cache memory (not shown). The memory can be a non-transitory computer-readable storage medium.

A removable mass storage device 1212 provides additional data storage capacity for the computer system 1200, and is coupled either bi-directionally (read/write) or uni-directionally (read only) to processor 1202. For example, storage 1212 can also include computer-readable media such as magnetic tape, flash memory, PC-CARDS, portable mass storage devices, holographic storage devices, and other storage devices. A fixed mass storage 1220 can also, for example, provide additional data storage capacity. The most common example of mass storage 1220 is a hard disk drive. Mass storage device 1212 and fixed mass storage 1220 generally store additional programming instructions, data, and the like that typically are not in active use by the processor 1202. It will be appreciated that the information retained within mass storage device 1212 and fixed mass storage 1220 can be incorporated, if needed, in standard fashion as part of memory 1210 (e.g., RAM) as virtual memory.

In addition to providing processor 1202 access to storage subsystems, bus 1214 can also be used to provide access to other subsystems and devices. As shown, these can include a display monitor 1218, a network interface 1216, a keyboard 1204, and a pointing device 1206, as well as an auxiliary input/output device interface, a sound card, speakers, and other subsystems as needed. For example, the pointing device 1206 can be a mouse, stylus, track ball, or tablet, and is useful for interacting with a graphical user interface.

The network interface 1216 allows processor 1202 to be coupled to another computer, computer network, or telecommunications network using a network connection as shown. For example, through the network interface 1216, the processor 1202 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1202 can be used to connect the computer system 1200 to an external network and transfer data according to standard protocols. For example, various process embodiments disclosed herein can be executed on processor 1202, or can be performed across a network such as the Internet, intranet networks, or local area networks, in conjunction with a remote processor that shares a portion of the processing. Additional mass storage devices (not shown) can also be connected to processor 1202 through network interface 1216.

An auxiliary I/O device interface (not shown) can be used in conjunction with computer system 1200. The auxiliary I/O device interface can include general and customized interfaces that allow the processor 1202 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 12 is but an example of a computer system suitable for use with the various embodiments disclosed herein. Other computer systems suitable for such use can include additional or fewer subsystems. In addition, bus 1214 is illustrative of any interconnection scheme serving to link the subsystems. Other computer architectures having different configurations of subsystems can also be utilized.

The systems, means, modules, or units illustrated by the above embodiments specifically may be implemented by computer chips or entities or by products having certain functions. A typical implementing device is a computer. The particular form a computer may take may be a personal computer, laptop computer, cellular phone, camera phone, smart phone, personal digital assistant, media player, navigation device, email receiving device, game console, tablet computer, wearable device, or a combination of any of these devices.

In a typical configuration, a computer comprises one or more processors (CPUs), input/output ports, network interfaces, and memory.

Memory may include the following forms in computer-readable media: volatile memory, random access memory (RAM), and/or non-volatile memory, e.g., read-only memory (ROM) or flash RAM. Memory is an example of a computer-readable medium.

Computer-readable media, including permanent and non-permanent and removable and non-removable media, may achieve information storage by any method or technology. The information may be computer-readable instructions, data structures, program modules, or other data. Examples of computer storage media include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk-read only memory (CD-ROM), digital versatile disk (DVD) or other optical storage, cassette tapes, magnetic tape and disk storage or other magnetic storage devices, or any other non-transmitting media that may be used to store computer-accessible information. In accordance with the definitions in this document, computer-readable media do not include transitory computer-readable media (transitory media) such as modulated data signals and carrier waves.

Please also note that the term “comprise” or “contain” or any of their variants are to be taken in their non-exclusive sense. Thus, processes, methods, merchandise, or devices that comprise a series of elements not only comprise those elements, but also comprise other elements that have not been explicitly listed or elements that are intrinsic to such processes, methods, merchandise, or devices. In the absence of further limitations, elements that are limited by the phrase “comprises a(n) . . . ” do not exclude the existence of additional identical elements in processes, methods, merchandise, or devices that comprise said elements.

Specific embodiments of this specification were described above. Other embodiments fall within the scope of the attached claims. In some situations, the actions or steps recorded in the claims may be executed according to sequences that differ from those in the embodiments, yet the expected result may still be achieved. In addition, the processes depicted in the drawings do not necessarily require the shown specific sequences or continuous sequences in order that the expected results be realized. In some implementations, multi-task processing and parallel processing may also be permissible or may be beneficial.

The terms used in one or more embodiments of this specification merely serve to describe specific embodiments and are not intended to restrict one or more embodiments of this specification. “A,” “said,” and “the” or “this” as used in their singular form in one or more embodiments of this specification and the claims also are intended to encompass the plural form, unless otherwise clearly indicated by the context. It is also important to understand that the term “and/or” as used herein refers to and encompasses any or all possible combinations of one or more inter-related listed items.

It is important to understand that, though the terms “first,” “second,” and “third” may be employed in one or more embodiments of this specification to describe various pieces of information, this information is not limited by these terms. These terms merely serve to differentiate between pieces of information of the same type. For example, without departing from the scope of one or more embodiments of this specification, “first information” may be called “second information,” and, similarly, “second information” may be called “first information.” Depending on context, the word “if” when used herein may be interpreted as “when” or “upon” or “in response to.”

The preferred embodiments of one or more embodiments of this specification that are described above are merely that and do not limit one or more embodiments of this specification. Any modification, equivalent substitution, or improvement that is made in keeping with the spirit and principles of one or more embodiments of this specification shall be included within the protective scope of one or more embodiments of this specification.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining, by one or more processors, input content from a communication session interface, the input content comprising one or more individual notification instruction identifiers and member characteristic information;
determining, by the one or more processors, one or more group members from among a predefined group, the one or more group members being determined based at least in part on the member characteristic information; and
adding, by the one or more processors, individual notification instruction information for the determined one or more group members to the communication session interface.

2. The method of claim 1, wherein the communication session interface corresponds to an interface for group communication.

3. The method of claim 1, wherein the individual notification instruction information is generated for each of the one or more group members.

4. The method of claim 1, wherein the individual notification instruction information is generated for each of the one or more group members, and the individual notification instruction information is indicative of a respective notification to be provided at one or more terminals respectively corresponding to the one or more group members.

5. The method of claim 1, wherein one or more subset groups are pre-created within the predefined group, and each subset group comprises at least one group member that belongs to the predefined group, the member characteristic information comprises: a group identifier for at least one subset group, and the determined one or more group members comprise: group members comprised within the at least one subset group.

6. The method of claim 1, wherein the member characteristic information comprises one or more characteristic description tags, and the determined one or more group members comprise: group members with respect to which the one or more characteristic description tags were pre-added.

7. The method of claim 6, wherein the one or more characteristic description tags include at least one of the following:
a self-descriptive tag added by any group member, a descriptive tag added by another group member, and a system-descriptive tag added by a communication application according to information associated with a corresponding group member.

8. The method of claim 6, wherein the characteristic description tags comprise: system preset tags or self-defined tags.

9. The method of claim 6, wherein the characteristic description tags with respect to the one or more group members are pre-added by a same user that input the input content, and the characteristic description tags are invisible to group members other than the user that input the input content.

10. The method of claim 1, wherein the one or more group members belong to a same organization, and the member characteristic information comprises: dimensional information comprised by an organizational structure of the organization, and the determined one or more group members comprise group members conforming to the dimensional information within the organization.

11. The method of claim 10, wherein the dimensional information comprises at least one of the following: an indication of a department dimension, an indication of a position grade, an indication of a work type, and an indication of a number of work years.

12. The method of claim 1, wherein group members of the predefined group belong to multiple organizations, the member characteristic information comprises organization information, and the determined one or more group members comprise group members belonging to corresponding organizations within the predefined group.

13. The method of claim 1, further comprising:
in response to a determination that the input content includes an individual notification instruction identifier, providing an information selection interface, the information selection interface comprising candidate member characteristic information; and
determining a selected candidate member characteristic information corresponding to the member characteristic information comprised in the input content based at least in part on a received selection.

14. The method of claim 1, further comprising:
in response to a determination that the input content includes an individual notification instruction identifier, providing a member selection interface, the member selection interface comprising group members matched to the input content,
wherein the determining the one or more group members within the group who conform to the member characteristic information comprises using a received member selection instruction in connection with determining the selected one or more group members as group members conforming to the member characteristic information.

15. The method of claim 1, wherein in response to receiving the individual notification instruction information, a notification is provided to at least one group member of the one or more group users determined based at least in part on the member characteristic information, the notification being provided even if a corresponding terminal of the at least one group member or client application running on the corresponding terminal has a do not disturb mode or silent mode activated.

16. The method of claim 1, wherein the determining of the one or more group members from among a predefined group comprises using the member characteristic information to determine one or more subsets of group members included in the predefined group match the predefined group.

17. The method of claim 1, wherein the determining of the one or more group members from among a predefined group comprises:
using the member characteristic information to determine one or more subsets of group members included in the predefined group match the predefined group;
presenting the one subsets of group members;
obtain a user selection with respect to selection of the determined one or more group members.

18. A device, comprising:
one or more processors configured to:
obtain input content from a communication session interface, the input content comprising one or more individual notification instruction identifiers and member characteristic information;
determine one or more group members from among a predefined group, the one or more group members being determined based at least in part on the member characteristic information; and
add individual notification instruction information for the determined one or more group members to the communication session interface; and
one or more memories coupled to the one or more processors, configured to provide the one or more processors with instructions.

19. The device of claim 15, wherein the individual notification instruction information is generated for each of the one or more group members, and the individual notification instruction information is indicative of a respective notification to be provided at one or more terminals respectively corresponding to the one or more group members.

20. A computer program product, the computer program product being embodied in a non-transitory computer readable storage medium and comprising computer instructions for:
obtaining, by one or more processors, input content from a communication session interface, the input content comprising one or more individual notification instruction identifiers and member characteristic information;
determining, by the one or more processors, one or more group members from among a predefined group, the one or more group members being determined based at least in part on the member characteristic information; and
adding, by the one or more processors, individual notification instruction information for the determined one or more group members to the communication session interface.
